(19) United States
(12) Patent Application Publication
(10) Pub. No.: US 2026/0237334 A1
(43) Pub. Date: Aug. 13, 2026

(54) ARRAY SUBSTRATE, DRIVING METHOD AND DISPLAY DEVICE

(71) Applicants: HEFEI BOE DISPLAY TECHNOLOGY CO., LTD., Hefei, Anhui (CN); BOE TECHNOLOGY GROUP CO., LTD., Beijing (CN)

(72) Inventors: Maoxiu Zhou, Beijing (CN); Ke Dai, Beijing (CN); Haipeng Yang, Beijing (CN); Min Cheng, Beijing (CN); Chunxu Zhang, Beijing (CN); Xiaoting Jiang, Beijing (CN)

(73) Assignees: HEFEI BOE DISPLAY TECHNOLOGY CO., LTD., Hefei, Anhui (CN); BOE TECHNOLOGY GROUP CO., LTD., Beijing (CN)

(21) Appl. No.: 19/147,799

(22) PCT Filed: Jul. 12, 2024
(86) PCT No.: PCT/CN2024/105061

§ 371 Date: Jul. 14, 2025

(30) Foreign Application Priority Data
Aug. 24, 2023 (CN) 202311075200.9

(51) Int. Cl. G09G 3/20

(52) U.S. Cl. CPC G09G 3/20; G09G 2300/0452; G09G 2310/0267; G09G 2310/0286; G09G 2310/08; G09G 2320/02

(57) ABSTRACT

An array substrate, a driving method and a display device are provided. The array substrate includes a driving module, a plurality of scanning lines, a plurality of data lines and a plurality of pixels. Two scanning lines are arranged between two adjacent rows of subpixels, and two columns of subpixels are arranged between two data lines. In a same row of subpixels, the subpixels electrically coupled to a same data line have at least two colors. In adjacent rows of subpixels, at least two subpixels electrically coupled to a same data line have a same color. The driving module is configured to control, within a display frame, that an overlapping time period and a non-overlapping time period are included between active time periods of the scanning signals provided by at least two scanning lines enabled sequentially.

### CROSS-REFERENCE TO RELATED APPLICATION

This application claims a priority of the Chinese patent application No. 202311075200.9 filed on Aug. 24, 2023, which is incorporated herein by reference in its entirety.

### TECHNICAL FIELD

The present disclosure relates to the field of display technology, in particular to an array substrate, a driving method and a display device.

### BACKGROUND

In the related art, for a pixel structure having dual-gate driving architecture, the quantity of data signal lines is reduced to reduce the quantity of channels of a source driving chip, thereby to reduce the display cost. Along the development of a display panel towards large size and high resolution, there is an urgent need in the display instruction to provide a scheme about how to ensure a display charge rate while taking the cost into consideration.

### SUMMARY

In one aspect, the present disclosure provides in some embodiments an array substrate, including a driving module, a plurality of scanning lines extending in a first direction, a plurality of data lines extending in a second direction, and a plurality of pixels. The pixel includes at least three subpixels having different colors, two scanning lines are arranged between two adjacent rows of subpixels, two columns of subpixels are arranged between two data lines, and the subpixel is electrically coupled to the scanning line and the data line and configured to receive a data voltage provided by the data line under the control of a scanning signal provided by the scanning line; in a same row of subpixels, the subpixels electrically coupled to a same data line have at least two colors; in adjacent rows of subpixels, at least two subpixels electrically coupled to a same data line have a same color; the driving module is configured to provide the scanning signal to the scanning line to control, within a display frame, that an overlapping time period and a non-overlapping time period are included between active time periods of the scanning signals provided by at least two scanning lines enabled sequentially; and the data voltage received by the data line within at least part of the overlapping time period is the same as the data voltage received by the data line within at least part of the non-overlapping time period.

In a possible embodiment of the present disclosure, subpixels in a (3a−2)^{th} column have a first color, subpixels in a (3a−1)^{th} column have a second color, and subpixels in a (3a)^{th} column have a third color, where a is a positive integer; subpixels in a (4m−3)^{th} row and odd-numbered columns are electrically coupled to an (8m−7)^{th} scanning line, and subpixels in the (4m−3)^{th} row and even-numbered columns are electrically coupled to an (8m−6)^{th} scanning line; subpixels in a (4m−2)^{th} row and the odd-numbered columns are electrically coupled to an (8m−4)^{th} scanning line, and subpixels in the (4m−2)^{th} row and the even-numbered columns are electrically coupled to an (8m−5)^{th} scanning line; subpixels in a (4m−1)^{th} row and the odd-numbered columns are electrically coupled to an (8m−2)^{th} scanning line, and subpixels in the (4m−1)^{th} row and the even-numbered columns are electrically coupled to an (8m−3)^{th} scanning line; and subpixels in a (4m)^{th} row and the odd-numbered columns are electrically coupled to an (8m−1)^{th} scanning line, and subpixels in the (4m)^{th} row and the even-numbered columns are electrically coupled to an (8m)^{th} scanning line, where a and m are both positive integers.

In a possible embodiment of the present disclosure, a subpixel in the (4m−3)^{th} row and a (2b−1)^{th} column, a subpixel in the (4m−2)^{th} row and the (2b−1)^{th} column, a subpixel in the (4m−3)^{th} row and a (2b)^{th} column and a subpixel in the (4m−2)^{th} row and the (2b)^{th} column are electrically coupled to a be data line; and a subpixel in the (4m−1)^{th} row and the (2b−1)^{th} column, a subpixel in the (4m−1)^{th} row and the (2b)^{th} column, a subpixel in the (4m)^{th} row and the (2b−1)^{th} column and a subpixel in the (4m)^{th} row and the (2b)^{th} column are electrically coupled to a (b+1)^{th} data line, where b is a positive integer.

In a possible embodiment of the present disclosure, an (8−7)^{th}-level driving circuit of the driving module is electrically coupled to a first clock signal line, and configured to generate an (8−7)^{th} scanning signal according to a first clock signal provided by the first clock signal line; an (8n−6)^{th}-level driving circuit of the driving module is electrically coupled to a second clock signal line, and configured to generate an (8n−4)^{th} scanning signal according to a second clock signal provided by the second clock signal line; an (8n−5)^{th}-level driving circuit of the driving module is electrically coupled to a third clock signal line, and configured to generate an (8n−6)^{th} scanning signal according to a third clock signal provided by the third clock signal line; an (8n−4)^{th}-level driving circuit of the driving module is electrically coupled to a fourth clock signal line, and configured to generate an (8n−5)^{th} scanning signal according to a fourth clock signal provided by the fourth clock signal line; an (8n−3)^{th}-level driving circuit of the driving module is electrically coupled to a fifth clock signal line, and configured to generate an (8n−5)^{th} scanning signal according to a fifth clock signal provided by the fifth clock signal line; an (8n−2)^{th}-level driving circuit of the driving module is electrically coupled to a sixth clock signal line, and configured to generate an (8n)^{th} scanning signal according to a sixth clock signal provided by the sixth clock signal line; an (8n−1)^{th}-level driving circuit of the driving module is electrically coupled to a seventh clock signal line, and configured to generate an (8n−2)^{th} scanning signal according to a seventh clock signal provided by the seventh clock signal line; an (8n)^{th}-level driving circuit of the driving module is electrically coupled to an eighth clock signal line, and configured to generate an (8n−1)^{th} scanning signal according to an eighth clock signal provided by the eighth clock signal line, where n is a positive integer.

In a possible embodiment of the present disclosure, an (8n−7)^{th}-level driving circuit of the driving module is electrically coupled to a first clock signal line, and configured to generate an (8n−7)^{th} scanning signal according to a first clock signal provided by the first clock signal line; an (8n−6)^{th}-level driving circuit of the driving module is electrically coupled to a third clock signal line, and configured to generate an (8n−6)^{th} scanning signal according to a third clock signal provided by the third clock signal line; an (8n−5)^{th}-level driving circuit of the driving module is electrically coupled to a fourth clock signal line, and configured to generate an (8n−5)^{th} scanning signal according to a fourth clock signal provided by the fourth clock signal line; an (8n−4)^{th}-level driving circuit of the driving module is electrically coupled to a second clock signal line, and configured to generate an (8n−4)^{th} scanning signal according to a second clock signal provided by the second clock signal line; an (8n−3)^{th}-level driving circuit of the driving module is electrically coupled to a fifth clock signal line, and configured to generate an (8n−3)^{th} scanning signal according to a fifth clock signal provided by the fifth clock signal line; an (8n−2)^{th}-level driving circuit of the driving module is electrically coupled to a seventh clock signal line, and configured to generate an (8n−2)^{th} scanning signal according to a seventh clock signal provided by the seventh clock signal line; an (8n−1)^{th}-level driving circuit of the driving module is electrically coupled to an eighth clock signal line, and configured to generate an (8n−1)^{th} scanning signal according to an eighth clock signal provided by the eighth clock signal line; an (8n)^{th}-level driving circuit of the driving module is electrically coupled to a sixth clock signal line, and configured to generate an (8n)^{th} scanning signal according to a sixth clock signal provided by the sixth clock signal line, where n is a positive integer.

In a possible embodiment of the present disclosure, subpixels in a (3a−2)^{th} column have a first color, subpixels in a (3a−1)^{th} column have a second color, and subpixels in a (3a)^{th} column have a third color, where a is a positive integer; subpixels in a (4m−2)^{th} row and odd-numbered columns are electrically coupled to an (8m−4)^{th} scanning line, and subpixels in the (4m−2)^{th} row and even-numbered columns are electrically coupled to an (8m−3)^{th} scanning line; subpixels in a (4m−1)^{th} row and the odd-numbered columns are electrically coupled to an (8m−3)^{th} scanning line, and subpixels in the (4m−1)^{th} row and the even-numbered columns are electrically coupled to an (8m−2)^{th} scanning line; subpixels in a (4m)^{th} row and the odd-numbered columns are electrically coupled to an (8m−1)^{th} scanning line, and subpixels in the (4m)^{th} row and the even-numbered columns are electrically coupled to an (8m)^{th} scanning line; and subpixels in a (4m+1)^{th} row and the odd-numbered columns are electrically coupled to an (8m+2)^{th} scanning line, and subpixels in the (4m+1)^{th} row and the even-numbered columns are electrically coupled to an (8m+1)^{th} scanning line, where a and m are both positive integers.

In a possible embodiment of the present disclosure, a subpixel in the (4m−2)^{th} row and a (2b−1)^{th} column, a subpixel in the (4m−2)^{th} row and a (2b)^{th} column, a subpixel in the (4m−1)^{th} row and the (2b−1)^{th} column and a subpixel in the (4m−1)^{th} row and the (2b)^{th} column are electrically coupled to a b^{th} data line; and a subpixel in the (4m)^{th} row and the (2b−1)^{th} column, a subpixel in the (4m)^{th} row and the (2b)^{th} column, a subpixel in the (4m+1)^{th} row and the (2b−1)^{th} column and a subpixel in the (4m+1)^{th} row and the (2b)^{th} column are electrically coupled to a (b+1)^{th} data line, where b is a positive integer.

In a possible embodiment of the present disclosure, subpixels in a first row and the odd-numbered columns are electrically coupled to a second scanning line, subpixels in the first row and the even-numbered columns are electrically coupled to a first scanning line, and a subpixel in the first row and the (2b−1)^{th} column and a subpixel in the first row and the (2b)^{th} column are both electrically coupled to the (b+1)^{th} data line.

In a possible embodiment of the present disclosure, an (8n−7)^{th}-level driving circuit of the driving module is electrically coupled to a first clock signal line, and configured to generate an (8n−7)^{th} scanning signal according to a first clock signal provided by the first clock signal line; an (8n−6)^{th}-level driving circuit of the driving module is electrically coupled to a second clock signal line, and configured to generate an (8n−6)^{th} scanning signal according to a second clock signal provided by the second clock signal line; an (8n−5)^{th}-level driving circuit of the driving module is electrically coupled to a third clock signal line, and configured to generate an (8n−5)^{th} scanning signal according to a third clock signal provided by the third clock signal line; an (8n−4)^{th}-level driving circuit of the driving module is electrically coupled to a fourth clock signal line, and configured to generate an (8n−4)^{th} scanning signal according to a fourth clock signal provided by the fourth clock signal line; an (8n−3)^{th}-level driving circuit of the driving module is electrically coupled to a fifth clock signal line, and configured to generate an (8n−3)^{th} scanning signal according to a fifth clock signal provided by the fifth clock signal line; an (8n−2)^{th}-level driving circuit of the driving module is electrically coupled to a sixth clock signal line, and configured to generate an (8n−2)^{th} scanning signal according to a sixth clock signal provided by the sixth clock signal line; an (8n−1)^{th}-level driving circuit of the driving module is electrically coupled to a seventh clock signal line, and configured to generate an (8n−1)^{th} scanning signal according to a seventh clock signal provided by the seventh clock signal line; an (8n)^{th}-level driving circuit of the driving module is electrically coupled to an eighth clock signal line, and configured to generate an (8n)^{th} scanning signal according to an eighth clock signal provided by the eighth clock signal line, where n is a positive integer.

In another aspect, the present disclosure provides in some embodiments a driving method, applied to the above-mentioned array substrate, including: receiving, by a subpixel, a data voltage provided by a data line under the control of a scanning signal provided by a scanning line; and providing, by a driving module, the scanning signal to the scanning line to control, within a display frame, that an overlapping time period and a non-overlapping time period are included between active time periods of the scanning signals provided by at least two scanning lines enabled sequentially. The data voltage received by the data line within at least part of the overlapping time period is the same as the data voltage received by the data line within at least part of the non-overlapping time period.

In a possible embodiment of the present disclosure, subpixels in a (3a−2)^{th} column have a first color, subpixels in a (3a−1)^{th} column have a second color, and subpixels in a (3a)^{th} column have a third color, where a is a positive integer; subpixels in a (4m−3)^{th} row and odd-numbered columns are electrically coupled to an (8m−7)^{th} scanning line, and subpixels in the (4m−3)^{th} row and even-numbered columns are electrically coupled to an (8m−6)^{th} scanning line; subpixels in a (4m−2)^{th} row and the odd-numbered columns are electrically coupled to an (8m−4)^{th} scanning line, and subpixels in the (4m−2)^{th} row and the even-numbered columns are electrically coupled to an (8m−5)^{th} scanning line; subpixels in a (4m−1)^{th} row and the odd-numbered columns are electrically coupled to an (8m−2)^{th} scanning line, and subpixels in the (4m−1)^{th} row and the even-numbered columns are electrically coupled to an (8m−3)^{th} scanning line; and subpixels in a (4m)^{th} row and the odd-numbered columns are electrically coupled to an (8m−1)^{th} scanning line, and subpixels in the (4m)^{th} row and the even-numbered columns are electrically coupled to an (8m)^{th} scanning line, where a and m are both positive integers; a subpixel in the (4m−3)^{th} row and a (2b−1)^{th} column, a subpixel in the (4m−2)^{th} row and the (2b−1)^{th} column, a subpixel in the (4m−3)^{th} row and a (2b)^{th} column and a subpixel in the (4m−2)^{th} row and the (2b)^{th} column are electrically coupled to a b^{th} data line; and a subpixel in the (4m−1)^{th} row and the (2b−1)^{th} column, a subpixel in the (4m−1)^{th} row and the (2b)^{th} column, a subpixel in the (4m)^{th} row and the (2b−1)^{th} column and a subpixel in the (4m)^{th} row and the (2b)^{th} column are electrically coupled to a (b+1)^{th} data line, where b is a positive integer. The driving method includes: controlling. by the driving module, an (8n−2)^{th} scanning line and an (8n−4)^{th} scanning line to be enabled sequentially, to control, within a subframe, that an overlapping time period and a non-overlapping time period are included in an active time period of an (8n−7)^{th} scanning signal and an active time period of an (8n−4)^{th} scanning signal; controlling, by the driving module, an (8n−6)^{th} scanning line and an (8n−5)^{th} scanning line to be enabled sequentially, to control, within a subframe, that an overlapping time period and a non-overlapping time period are included in an active time period of an (8n−6)^{th} scanning signal and an active time period of an (8n−5)^{th} scanning signal; controlling, by the driving module, an (8n−3)^{th} scanning line and an (8n)^{th} scanning line to be enabled sequentially, to control, within a subframe, that an overlapping time period and a non-overlapping time period are included in an active time period of an (8n−3)^{th} scanning signal and an active time period of an (8n)^{th} scanning signal; and controlling, by the driving module, an (8n−2)^{th} scanning line and an (8n−2)^{th} scanning line to be enabled sequentially, to control, within a subframe, that an overlapping time period and a non-overlapping time period are included in an active time period of an (8n−2)^{th} scanning signal and an active time period of an (8n−1)^{th} scanning signal, where n is a positive integer.

In a possible embodiment of the present disclosure, subpixels in a (3a−2)^{th} column have a first color, subpixels in a (3a−1)^{th} column have a second color, and subpixels in a (3a)^{th} column have a third color, where a is a positive integer; subpixels in a (4m−2)^{th} row and odd-numbered columns are electrically coupled to an (8m−4)^{th} scanning line, and subpixels in the (4m−2)^{th} row and even-numbered columns are electrically coupled to an (8m−3)^{th} scanning line; subpixels in a (4m−1)^{th} row and the odd-numbered columns are electrically coupled to an (8m−3)^{th} scanning line, and subpixels in the (4m−1)^{th} row and the even-numbered columns are electrically coupled to an (8m−2)^{th} scanning line; subpixels in a (4m)^{th} row and the odd-numbered columns are electrically coupled to an (8m−1)^{th} scanning line, and subpixels in the (4m)^{th} row and the even-numbered columns are electrically coupled to an (8m)^{th} scanning line; and subpixels in a (4m+1)^{th} row and the odd-numbered columns are electrically coupled to an (8m+2)^{th} scanning line, and subpixels in the (4m+1)^{th} row and the even-numbered columns are electrically coupled to an (8m+1)^{th} scanning line, where a and m are both positive integers; a subpixel in the (4m−2)^{th} row and a (2b−1)^{th} column, a subpixel in the (4m−2)^{th} row and a (2b)^{th} column, a subpixel in the (4m−1)^{th} row and the (2b−1)^{th} column and a subpixel in the (4m−1)^{th} row and the (2b)^{th} column are electrically coupled to a b^{th} data line; and a subpixel in the (4m)^{th} row and the (2b−1)^{th} column, a subpixel in the (4m)^{th} row and the (2b)^{th} column, a subpixel in the (4m+1)^{th} row and the (2b−1)^{th} column and a subpixel in the (4m+1)^{th} row and the (2b)^{th} column are electrically coupled to a (b+1)^{th} data line, where b is a positive integer. The driving method includes: controlling, by the driving module, an (8n−6)^{th} scanning line and an (8n−5)^{th} scanning line to be enabled sequentially, to control, within a subframe, that an overlapping time period and a non-overlapping time period are included in an active time period of an (8n−6)^{th} scanning signal and an active time period of an (8n−5)^{th} scanning signal; controlling, by the driving module, an (8n−4)^{th} scanning line and an (8n−3)^{th} scanning line to be enabled sequentially, to control, within a subframe, that an overlapping time period and a non-overlapping time period are included in an active time period of an (8n−4)^{th} scanning signal and an active time period of an (8n−3)^{th} scanning signal; controlling, by the driving module, an (8n−2)^{th} scanning line and an (8n−1)^{th} scanning line to be enabled sequentially, to control, within a subframe, that an overlapping time period and a non-overlapping time period are included in an active time period of an (8n−2)^{th} scanning signal and an active time period of an (8n−1)^{th} scanning signal; and controlling, by the driving module, an (8n)^{th} scanning line and an (8n+1)^{th} scanning line to be enabled sequentially, to control, within a subframe, that an overlapping time period and a non-overlapping time period are included in an active time period of an (8n)^{th} scanning signal and an active time period of an (8n+1)^{th} scanning signal, where n is a positive integer.

In a possible embodiment of the present disclosure, subpixels in a first row and the odd-numbered column are electrically coupled to a second scanning line, subpixels in the first row and the even-numbered columns are electrically coupled to a first scanning line, and a subpixel in the first row and the (2b−1)^{th} column and a subpixel in the first row and the (2b)^{th} column are both electrically coupled to the (b+1)^{th} data line. The driving method further includes, prior to enabling the second scanning line, controlling, by the driving module, the first scanning line to be enabled, and no overlapping time period is included between an active time period of a first scanning signal provided by the first scanning line and an active time period of a scanning signal provided by the other scanning line.

In yet another aspect, the present disclosure provides in some embodiments a display device including the above-mentioned array substrate.

### BRIEF DESCRIPTION OF THE DRAWINGS

FIG. 1 is a schematic view showing an array substrate according to at least one embodiment of the present disclosure;

FIG. 2 is a schematic view showing a driving module in the array substrate according to at least one embodiment of the present disclosure;

FIG. 3 is a sequence diagram of signals in FIG. 2;

FIG. 4 is a schematic view showing the driving module in the array substrate according to at least one embodiment of the present disclosure;

FIG. 5 is a sequence diagram of signals in FIG. 4;

FIG. 6 is a schematic view showing the array substrate according to at least one embodiment of the present disclosure;

FIG. 7 is schematic view showing the driving module in the array substrate according to at least one embodiment of the present disclosure; and

FIG. 8 is a sequence diagram of signals in FIG. 7

### DETAILED DESCRIPTION

The present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

All transistors adopted in the embodiments of the present disclosure may be thin film transistors, field effect transistors or any other elements having an identical characteristic. In order to differentiate two electrodes other than a gate electrode from each other, one of the two electrodes is called as first electrode and the other is called as second electrode.

In actual use, when the transistor is a thin film transistor or field effect transistor, the first electrode may be a drain electrode and the second electrode may be a source electrode, or the first electrode may be a source electrode and the second electrode may be a drain electrode.

The present disclosure provides in some embodiments an array substrate, which includes a driving module, a plurality of scanning lines extending in a first direction, a plurality of data lines extending in a second direction, and a plurality of pixels. The pixel includes at least three subpixels having different colors, two scanning lines are arranged between two adjacent rows of subpixels, two columns of subpixels are arranged between two data lines, and the subpixel is electrically coupled to the scanning line and the data line and configured to receive a data voltage provided by the data line under the control of a scanning signal provided by the scanning line; in a same row of subpixels, the subpixels electrically coupled to a same data line have at least two colors; in adjacent rows of subpixels, at least two subpixels electrically coupled to a same data line have a same color; the driving module is configured to provide the scanning signal to the scanning line to control, within a display frame, that an overlapping time period and a non-overlapping time period are included between active time periods of the scanning signals provided by at least two scanning lines enabled sequentially; and the data voltage received by the data line within at least part of the overlapping time period is the same as the data voltage received by the data line within at least part of the non-overlapping time period.

According to the array substrate in the embodiments of the present disclosure, two scanning lines are arranged between adjacent two rows of subpixels, and two columns of subpixels are arranged between two data lines. In a same row of subpixels, the subpixels electrically coupled to a same data line have at least two colors. In adjacent rows of subpixels, at least two subpixels electrically coupled to a same data line have a same color. The driving module is configured to provide a scanning signal to the scanning line to control, within a display frame, that an overlapping time period and a non-overlapping time period are included between active time periods of the scanning signals provided by at least two scanning lines enabled sequentially, and the data voltage received by the data line within at least part of the overlapping time period is the same as the data voltage received by the data line within at least part of the non-overlapping time period. In the embodiments of the present disclosure, a pixel structure having dual-gate architecture has a Hardware Super Resolution (HSR) function, so as to increase a charging time of at least part of the subpixels while reducing the cost, increase a charging rate and a refresh rate, and improve the display quality.

In the related art, for a large-size display product including the pixel structure having dual-gate driving architecture, there exist such problems as horizontal stripes and vertical stripes. However, in the dual-gate driving pixel structure adopted in the embodiments of the present disclosure, it is able to prevent the occurrent of the horizontal stripes and vertical stripes. In addition, in order to increase the charging rate and display an image at a high resolution, the HSR function is adopted.

In the embodiments of the present disclosure, through the adjustment of an output of a driving circuit, an output in a 120 Hz HSR mode is achieved, the image quality is not adversely affected in a 60 Hz mode, and it is able to use a screen for multiple purposes. In addition, the manufacture cost does not increase, so it is able to reduce the cost of a display panel.

In at least one embodiment of the present disclosure, subpixels in a (3a−2)^{th} column have a first color, subpixels in a (3a−1)^{th} column have a second color, and subpixels in a (3a)^{th} column have a third color, where a is a positive integer; subpixels in a (4m−3)^{th} row and odd-numbered columns are electrically coupled to an (8m−7)^{th} scanning line, and subpixels in the (4m−3)^{th} row and even-numbered columns are electrically coupled to an (8m−6)^{th} scanning line; subpixels in a (4m−2)^{th} row and the odd-numbered columns are electrically coupled to an (8m−4)^{th} scanning line, and subpixels in the (4m−2)^{th} row and the even-numbered columns are electrically coupled to an (8m−5)^{th} scanning line; subpixels in a (4m−1)^{th} row and the odd-numbered columns are electrically coupled to an (8m−2)^{th} scanning line, and subpixels in the (4m−1)^{th} row and the even-numbered columns are electrically coupled to an (8m−3)^{th} scanning line; and subpixels in a (4m)^{th} row and the odd-numbered columns are electrically coupled to an (8m−1)^{th} scanning line, and subpixels in the (4m)^{th} row and the even-numbered columns are electrically coupled to an (8m)^{th} scanning line, where a and m are both positive integers.

In a possible embodiment of the present disclosure, a subpixel in the (4m−3)^{th} row and a (2b−1)^{th} column, a subpixel in the (4m−2)^{th} row and the (2b−1)^{th} column, a subpixel in the (4m−3)^{th} row and a (2b)^{th} column and a subpixel in the (4m−2)^{th} row and the (2b)^{th} column are electrically coupled to a b^{th} data line; and a subpixel in the (4m−1)^{th} row and the (2b−1)^{th} column, a subpixel in the (4m−1)^{th} row and the (2b)^{th} column, a subpixel in the (4m)^{th} row and the (2b−1)^{th} column and a subpixel in the (4m)^{th} row and the (2b)^{th} column are electrically coupled to a (b+1)^{th} data line, where b is a positive integer.

In at least one embodiment of the present disclosure, an (8n−7)^{th}-level driving circuit of the driving module is electrically coupled to a first clock signal line, and configured to generate an (8n−7)^{th} scanning signal according to a first clock signal provided by the first clock signal line; an (8n−6)^{th}-level driving circuit of the driving module is electrically coupled to a second clock signal line, and configured to generate an (8n−4)^{th} scanning signal according to a second clock signal provided by the second clock signal line; an (8n−5)^{th}-level driving circuit of the driving module is electrically coupled to a third clock signal line, and configured to generate an (8n−6)^{th} scanning signal according to a third clock signal provided by the third clock signal line; an (8n−4)^{th}-level driving circuit of the driving module is electrically coupled to a fourth clock signal line, and configured to generate an (8n−5)^{th} scanning signal according to a fourth clock signal provided by the fourth clock signal line; an (8n−3)^{th}-level driving circuit of the driving module is electrically coupled to a fifth clock signal line, and configured to generate an (8n−5)^{th} scanning signal according to a fifth clock signal provided by the fifth clock signal line; an (8n−2)^{th}-level driving circuit of the driving module is electrically coupled to a sixth clock signal line, and configured to generate an (8n)^{th} scanning signal according to a sixth clock signal provided by the sixth clock signal line; an (8n−1)^{th}-level driving circuit of the driving module is electrically coupled to a seventh clock signal line, and configured to generate an (8n−2)^{th} scanning signal according to a seventh clock signal provided by the seventh clock signal line; an (8n)^{th}-level driving circuit of the driving module is electrically coupled to an eighth clock signal line, and configured to generate an (8n−1)^{th} scanning signal according to an eighth clock signal provided by the eighth clock signal line, where n is a positive integer.

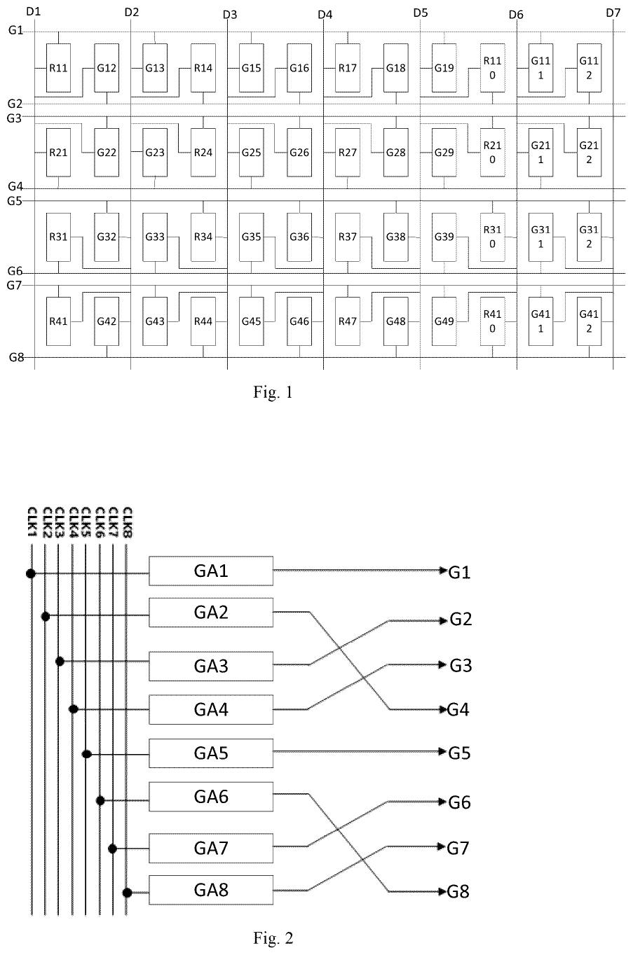

As shown in FIG. 1, for example, the array substrate in at least one embodiment of the present disclosure includes a first scanning line G1, a second scanning line G2, a third scanning line G3, a fourth scanning line G4, a fifth scanning line G5, a sixth scanning line G6, a seventh scanning line G8, a first data line D1, a second data line D2, a third data line D3, a fourth data line D4, a fifth data line D5, a sixth data line D6 and a seventh data line D7.

The array substrate in at least one embodiment of the present disclosure further includes a red subpixel R11 in a first row and a first column, a green subpixel G12 in the first row and a second column, a blue subpixel B13 in the first row and a third column, a red subpixel R14 in the first row and a fourth column, a green subpixel G15 in the first row and a fifth column, a blue subpixel B16 in the first row and a sixth column, a red subpixel R17 in the first row and a seventh column, a green subpixel G18 in the first row and an eighth column, a blue subpixel B19 in the first row and a ninth column, a red subpixel R110 in the first row and a tenth column, a green subpixel G111 in the first row and an eleventh column, a blue subpixel B112 in the first row and a twelfth column, a red subpixel R21 in a second row and the first column, a green subpixel G22 in the second row and the second column, a blue subpixel B23 in the second row and the third column, a red subpixel R24 in the second row and the fourth column, a green subpixel G25 in the second row and the fifth column, a blue subpixel B26 in the second row and the sixth column, a red subpixel R27 in the second row and the seventh column, a green subpixel G28 in the second row and the eighth column, a blue subpixel B29 in the second row and the ninth column, a red subpixel R210 in the second row and the tenth column, a green subpixel G211 in the second row and the eleventh column, a blue subpixel B212 in the second row and the twelfth column, a red subpixel R31 in a third row and the first column, a green subpixel G32 in the third row and the second column, a blue subpixel B33 in the third row and the third column, a red subpixel R34 in the third row and the fourth column, a green subpixel G35 in the third row and the fifth column, a blue subpixel B36 in the third row and the sixth column, a red subpixel R37 in the third row and the seventh column, a green subpixel G38 in the third row and the eighth column, a blue subpixel B39 in the third row and the ninth column, a red subpixel R310 in the third row and the tenth column, a green subpixel G311 in the third row and the eleventh column, a blue subpixel B312 in the third row and the twelfth column, a red subpixel R41 in a fourth row and the first column, a green subpixel G42 in the fourth row and the second column, a blue subpixel B43 in the fourth row and the third column, a red subpixel R44 in the fourth row and the fourth column, a green subpixel G45 in the fourth row and the fifth column, a blue subpixel B46 in the fourth row and the sixth column, a red subpixel R47 in the fourth row and the seventh column, a green subpixel G48 in the fourth row and the eighth column, a blue subpixel B49 in the fourth row and the ninth column, a red subpixel R410 in the fourth row and the tenth column, a green subpixel G411 in the fourth row and the eleventh column, and a blue subpixel B412 in the fourth row and the twelfth column.

R11 is electrically coupled to G1 and D1, and G12 is electrically coupled to G2 and D1; B13 is electrically coupled to G1 and D2, and R14 is electrically coupled to G2 and D2; G15 is electrically coupled to G1 and D3, and B16 is electrically coupled to G2 and D3; R17 is electrically coupled to G1 and D4, and G18 is electrically coupled to G2 and D4; B19 is electrically coupled to G1 and D5, and R110 is electrically coupled to G2 and D5; G111 is electrically coupled to G1 and D6, and B112 is electrically coupled to G2 and D6; R21 is electrically coupled to G4 and D1, and G22 is electrically coupled to G3 and D1; B23 is electrically coupled to G4 and D2, and R24 is electrically coupled to G3 and D2; G25 is electrically coupled to G4 and D3, and B26 is electrically coupled to G3 and D3; R27 is electrically coupled to G4 and D4, and G28 is electrically coupled to G3 and D4; B29 is electrically coupled to G4 and D5, and R210 is electrically coupled to G3 and D5; G211 is electrically coupled to G4 and D6, and B212 is electrically coupled to G3 and D6; R31 is electrically coupled to G6 and D2, G32 is electrically coupled to G5 and D2; B33 is electrically coupled to G6 and D3, and R34 is electrically coupled to G5 and D3; G35 is electrically coupled to G6 and D4, and B36 is electrically coupled to G5 and D4; R37 is electrically coupled to G6 and D5, and G38 is electrically coupled to G5 and D5; B39 is electrically coupled to G6 and D6, and R310 is electrically coupled to G5 and D6; G311 is electrically coupled to G6 and D7, and B312 is electrically coupled to G5 and D7; R41 is electrically coupled to G7 and D2, and G32 is electrically coupled to G8 and D2; B43 is electrically coupled to G7 and D3, and R44 is electrically coupled to G8 and D3; G45 is electrically coupled to G7 and D4, and B46 is electrically coupled to G8 and D4; R47 is electrically coupled to G7 and D5, and G48 is electrically coupled to G8 and D5; B49 is electrically coupled to G7 and D6, and R410 is electrically coupled to GS and D6; and G411 is electrically coupled to G7 and D7, and R412 is electrically coupled to G8 and D7.

As shown in FIG. 2, the driving module includes a first-level driving circuit GAI, a second-level driving circuit GA2, a third-level driving circuit GA3, a fourth-level driving circuit GA4, a fifth-level driving circuit GA5, a sixth-level driving circuit GA6, a seventh-level driving circuit GA7 and an eighth-level driving circuit GAS. GAI is electrically coupled to a first clock signal line CLK1, and configured to generate a first scanning signal according to a first clock signal provided by the first clock signal line CLK1, and provide the first scanning signal to the first scanning line G1. GA2 is electrically coupled to a second clock signal line CLK2, and configured to generate a fourth scanning signal according to a second clock signal provided by the second clock signal line CLK2, and provide the fourth scanning signal to the fourth scanning line G4. GA3 is electrically coupled to a third clock signal line CLK3, and configured to generate a second scanning signal according to a third clock signal provided by the third clock signal line CLK3, and provide the second scanning signal to the second scanning line G2. GA4 is electrically coupled to a fourth clock signal line CLK4, and configured to generate a third scanning signal according to a fourth clock signal provided by the fourth clock signal line CLK4, and provide the third scanning signal to the third scanning line G3. GA5 is electrically coupled to a fifth clock signal line CLK5, and configured to generate a fifth scanning signal according to a fifth clock signal provided by the fifth clock signal line CLK5, and provide the fifth scanning signal to the fifth scanning line G5. GA6 is electrically coupled to a sixth clock signal line CLK6, and configured to generate an eighth scanning signal according to a sixth clock signal provided by the sixth clock signal line CLK6, and provide the eighth scanning signal to the eighth scanning line G8. GA7 is electrically coupled to a seventh clock signal line CLK7, and configured to generate a sixth scanning signal according to a seventh clock signal provided by the seventh clock signal line CLK7, and provide the sixth scanning signal to the sixth scanning line G6. GAS is electrically coupled to an eighth clock signal line CLK8, and configured to generate a seventh scanning signal according to an eighth clock signal provided by the eighth clock signal line CLK8, and provide the seventh scanning signal to the seventh scanning line G7.

As shown in FIG. 2, some lines between driving signal output ends of the driving circuits in the driving module intersects and the scanning lines of the display panel intersect, and the lines are insulated from each other at an intersection.

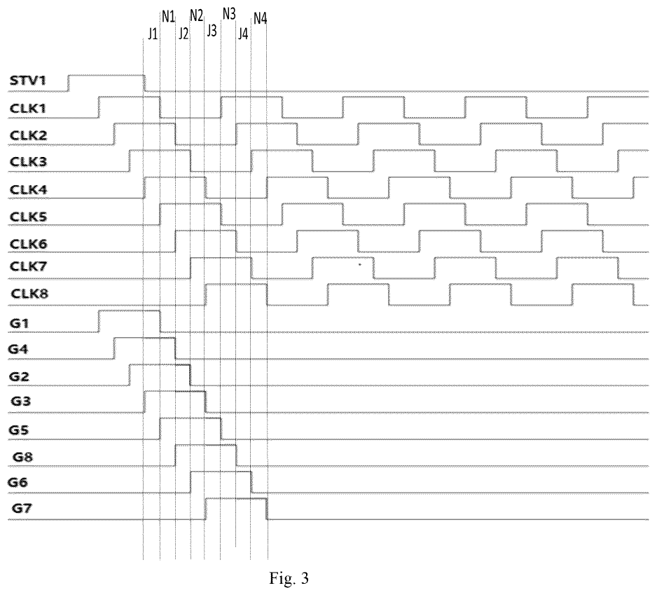

The driving module in FIG. 2 provides the scanning signal for the pixel structure in FIG. 1. FIG. 3 is a sequence diagram of the signals in FIG. 2.

In FIG. 3, STV represents a start signal received by G1.

As shown in FIG. 3, a duty ratio of the first clock signal, a duty ratio of the second clock signal, a duty ratio of the third clock signal, a duty ratio of the fourth clock signal, a duty ratio of the fifth clock signal, a duty ratio of the sixth clock signal, a duty ratio of the seventh clock signal and a duty ratio of the eighth clock signal are all ½. A period of the first clock signal, a period of the second clock signal, a period of the third clock signal, a period of the fourth clock signal, a period of the fifth clock signal, a period of the sixth clock signal, a period of the seventh clock signal and a period of the eighth clock signal are all T, i.e., a high level and an adjacent low level of the clock signal have a same period. The second clock signal is delayed relative to the first clock signal by T/8, the third cock signal is delayed relative to the second clock signal by T/8, the fourth clock signal is delayed relative to the third clock signal by T/8, the fifth clock signal is delayed relative to the fourth clock signal by T/8, the sixth clock signal is delayed relative to the fifth clock signal by T/8, the seventh clock signal is delayed relative to the sixth clock signal by T/8, and the eighth clock signal is delayed relative to the seventh clock signal by T/8.

During the operation of the driving module in FIG. 3, the clock signal lines CLK1, CLK2, CLK3, CLK4, CLK5, CLK6, CLK7 and CLK8 are enabled sequentially, and G1, G4, G2, G3, G5, G8, Go and G7 are enabled sequentially. A first overlapping time period J1 and a first non-overlapping time period N1 are included between an active time period of the first scanning signal provided by G1 and an active time period of the fourth scanning signal provided by G4. It should be appreciated that, in the embodiments of the present disclosure, the active time period refers to a time period within which a signal is at a high level in a case that a transistor at a display region of the display panel electrically coupled to a pixel electrode is an N-type transistor, or a time period within which a signal is at a low level in a case that the transistor at the display region of the display panel electrically coupled to the pixel electrode is a P-type transistor. In the embodiments of the present disclosure, the high level is taken as an active level, but the present disclosure is not limited thereto.

A second overlapping time period J2 and a second non-overlapping time period N2 are included between an active time period of the second scanning signal provided by G2 and an active time period of the third scanning signal provided by G3. A third overlapping time period J3 and a third non-overlapping time period N3 are included between an active time period of the fifth scanning signal provided by G5 and an active time period of the eighth scanning signal provided by G8. A fourth overlapping time period J4 and a fourth non-overlapping time period N4 are included between an active time period of the sixth scanning signal provided by G6 and an active time period of the seventh scanning signal provided by G7.

A data voltage received by the data line within at least part of the first overlapping time period J1 is the same as a data voltage received by the data line within at least part of the first non-overlapping time period N1. A data voltage received by the data line within at least part of the second overlapping time period J2 is the same as a data voltage received by the data line within at least part of the second non-overlapping time period N2. A data voltage received by the data line within at least part of the third overlapping time period J3 is the same as a data voltage received by the data line within at least part of the third non-overlapping time period N3. A data voltage received by the data line within at least part of the fourth overlapping time period J4 is the same as a data voltage received by the data line within at least part of the fourth non-overlapping time period N4.

In a possible embodiment of the present disclosure, the data voltage received within the overlapping time period is the same as that received within the non-overlapping time period. For example, the data voltage received within the first overlapping time period J1 is the same as the data voltage received within the first non-overlapping time period N1, the data voltage received within the second overlapping time period J2 is the same as the data voltage received within the second non-overlapping time period N2, the data voltage received within the third overlapping time period J3 is the same as the data voltage received within the third non-overlapping time period N3, and so on.

As shown in FIG. 3, in a possible embodiment of the present disclosure, a charging time for the subpixels controlled by G1 is 1H (a charging time for one row), and J1=1H. A charging time for the subpixels controlled by G4 is 2H, and J1+N1=2H. A data signal provided to a pixel in a case that the charging time for the subpixels controlled by G1 is 1H is the same as a data signal provided to the pixel in a case that the charging time for the subpixels controlled by G4 is 2H. A charging time for the subpixels controlled by G2 is 1H, a charging time for the subpixels controlled by G3 is 2H, and a data signal provided to a pixel in a case that the charging time for the subpixels controlled by G2 is 1H is the same as a data signal provided to the pixel in a case that the charging time for the subpixels controlled by G3 is 2H. A charging time for the subpixels controlled by G5 is 1H, a charging time for the subpixels controlled by G8 is 2H, and a data signal provided to a pixel in a case that the charging time for the subpixels controlled by G5 is 1H is the same as a data signal provided to the pixel in a case that the charging time for the subpixels controlled by G8 is 2H. A charging time for the subpixels controlled by G6 is 1H, a charging time for the subpixels controlled by G7 is 2H, and a data signal provided to a pixel in a case that the charging time for the subpixels controlled by G6 is 1H is the same as a data signal provided to the pixel in a case that the charging time for the subpixels controlled by G7 is 2H.

In at least one embodiment of the present disclosure, an (8n−7)^{th}-level driving circuit of the driving module is electrically coupled to a first clock signal line, and configured to generate an (8n−7)^{th} scanning signal according to a first clock signal provided by the first clock signal line; an (8n−6)^{th}-level driving circuit of the driving module is electrically coupled to a third clock signal line, and configured to generate an (8n−6)^{th} scanning signal according to a third clock signal provided by the third clock signal line; an (8n−5)^{th}-level driving circuit of the driving module is electrically coupled to a fourth clock signal line, and configured to generate an (8n−5)^{th} scanning signal according to a fourth clock signal provided by the fourth clock signal line; an (8n−4)^{th}-level driving circuit of the driving module is electrically coupled to a second clock signal line, and configured to generate an (8n−4)^{th} scanning signal according to a second clock signal provided by the second clock signal line; an (8n−3)^{th}-level driving circuit of the driving module is electrically coupled to a fifth clock signal line, and configured to generate an (8n−3)^{th} scanning signal according to a fifth clock signal provided by the fifth clock signal line; an (8n−2)^{th}-level driving circuit of the driving module is electrically coupled to a seventh clock signal line, and configured to generate an (8n−2)^{th} scanning signal according to a seventh clock signal provided by the seventh clock signal line; an (8n−1)^{th}-level driving circuit of the driving module is electrically coupled to an eighth clock signal line, and configured to generate an (8n−1)^{th} scanning signal according to an eighth clock signal provided by the eighth clock signal line; an (8n)^{th}-level driving circuit of the driving module is electrically coupled to a sixth clock signal line, and configured to generate an (8n)^{th} scanning signal according to a sixth clock signal provided by the sixth clock signal line, where n is a positive integer.

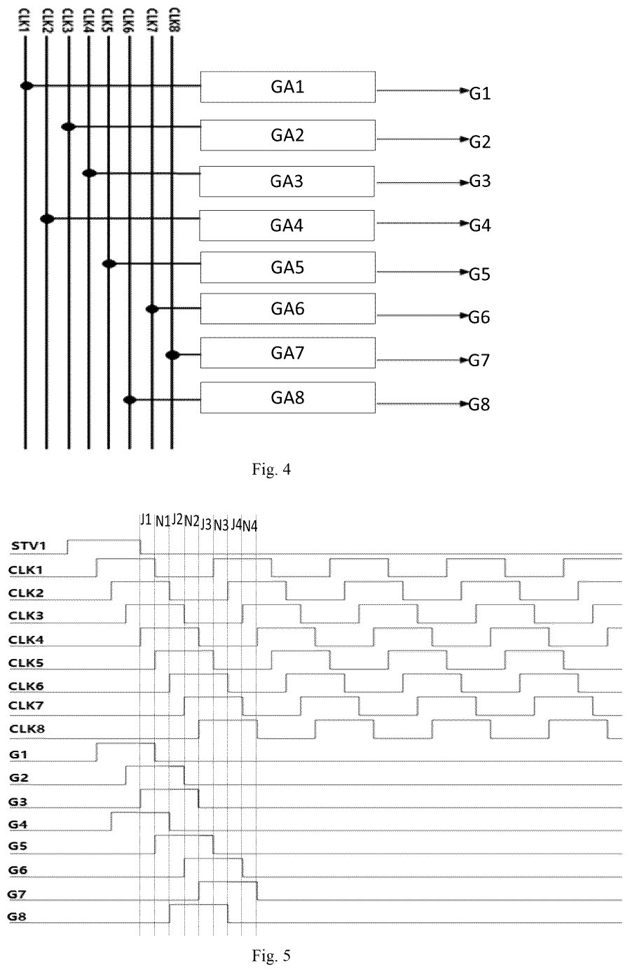

As shown in FIG. 4, the driving module includes a first-level driving circuit GA1, a second-level driving circuit GA2, a third-level driving circuit GA3, a fourth-level driving circuit GA4, a fifth-level driving circuit GA5, a sixth-level driving circuit GA6, a seventh-level driving circuit GA7 and an eighth-level driving circuit GA8.

The driving module in FIG. 4 provides the scanning signal for the pixel structure in FIG. 1. GAI is electrically coupled to a first clock signal line CLK1, and configured to generate a first scanning signal according to a first clock signal provided by the first clock signal line CLK1, and provide the first scanning signal to the first scanning line G1. GA2 is electrically coupled to a third clock signal line CLK3, and configured to generate a second scanning signal according to a third clock signal provided by the third clock signal line CLK3, and provide the second scanning signal to the fourth scanning line G2. GA3 is electrically coupled to a fourth clock signal line CLK4, and configured to generate a third scanning signal according to a fourth clock signal provided by the fourth clock signal line CLK4, and provide the third scanning signal to the third scanning line G3. GA4 is electrically coupled to a second clock signal line CLK2, and configured to generate a fourth scanning signal according to a second clock signal provided by the second clock signal line CLK2, and provide the fourth scanning signal to the fourth scanning line G4. GA5 is electrically coupled to a fifth clock signal line CLK5, and configured to generate a fifth scanning signal according to a fifth clock signal provided by the fifth clock signal line CLK5, and provide the fifth scanning signal to the fifth scanning line G5. GA6 is electrically coupled to a seventh clock signal line CLK7, and configured to generate a sixth scanning signal according to a seventh clock signal provided by the seventh clock signal line CLK7, and provide the sixth scanning signal to the sixth scanning line G6. GA7 is electrically coupled to an eighth clock signal line CLK8, and configured to generate a seventh scanning signal according to an eighth clock signal provided by the eighth clock signal line CLK8, and provide the seventh scanning signal to the seventh scanning line G7. GAS is electrically coupled to a sixth clock signal line CLK6, and configured to generate a sixth scanning signal according to a sixth clock signal provided by the seventh clock signal line CLK6, and provide the sixth scanning signal to the eighth scanning line G8.

FIG. 5 is a sequence diagram of the signals in FIG. 4.

In FIG. 5, STV represents a start signal received by G1.

As shown in FIG. 3, a duty ratio of the first clock signal, a duty ratio of the second clock signal, a duty ratio of the third clock signal, a duty ratio of the fourth clock signal, a duty ratio of the fifth clock signal, a duty ratio of the sixth clock signal, a duty ratio of the seventh clock signal and a duty ratio of the eighth clock signal are all ½. A period of the first clock signal, a period of the second clock signal, a period of the third clock signal, a period of the fourth clock signal, a period of the fifth clock signal, a period of the sixth clock signal, a period of the seventh clock signal and a period of the eighth clock signal are all T. The second clock signal is delayed relative to the first clock signal by T/8, the third cock signal is delayed relative to the second clock signal by T/8, the fourth clock signal is delayed relative to the third clock signal by T/8, the fifth clock signal is delayed relative to the fourth clock signal by T/8, the sixth clock signal is delayed relative to the fifth clock signal by T/8, the seventh clock signal is delayed relative to the sixth clock signal by T/8, and the eighth clock signal is delayed relative to the seventh clock signal by T/8.

During the operation of the driving module in FIG. 5, the clock signal lines CLK1, CLK2, CLK3, CLK4, CLK5, CLK6, CLK7 and CLK8 are enabled sequentially, and G1, G4, G2, G3, G5, G8, G6 and G7 are enabled sequentially. A first overlapping time period J1 and a first non-overlapping time period N1 are included between an active time period of the first scanning signal provided by G1 and an active time period of the fourth scanning signal provided by G4. A second overlapping time period J2 and a second non-overlapping time period N2 are included between an active time period of the second scanning signal provided by G2 and an active time period of the third scanning signal provided by G3. A third overlapping time period J3 and a third non-overlapping time period N3 are included between an active time period of the fifth scanning signal provided by G5 and an active time period of the eighth scanning signal provided by G8. A fourth overlapping time period J4 and a fourth non-overlapping time period N4 are included between an active time period of the sixth scanning signal provided by G6 and an active time period of the seventh scanning signal provided by G7 A data voltage received by the data line within at least part of the first overlapping time period J1 is the same as a data voltage received by the data line within at least part of the first non-overlapping time period N1. A data voltage received by the data line within at least part of the second overlapping time period J2 is the same as a data voltage received by the data line within at least part of the second non-overlapping time period N2. A data voltage received by the data line within at least part of the third overlapping time period J3 is the same as a data voltage received by the data line within at least part of the third non-overlapping time period N3. A data voltage received by the data line within at least part of the fourth overlapping time period J4 is the same as a data voltage received by the data line within at least part of the fourth non-overlapping time period N4.

In a possible embodiment of the present disclosure, the data voltage received within the overlapping time period is the same as that received within the non-overlapping time period. For example, the data voltage received within the first overlapping time period J1 is the same as the data voltage received within the first non-overlapping time period N1, the data voltage received within the second overlapping time period J2 is the same as the data voltage received within the second non-overlapping time period N2, the data voltage received within the third overlapping time period J3 is the same as the data voltage received within the third non-overlapping time period N3, and so on.

As shown in FIG. 5, in a possible embodiment of the present disclosure, a charging time for the subpixels controlled by G1 is 1H (a charging time for one row), a charging time for the subpixels controlled by G4 is 2H, and a data signal provided to a pixel in a case that the charging time for the subpixels controlled by G1 is 1H is the same as a data signal provided to the pixel in a case that the charging time for the subpixels controlled by G4 is 2H. A charging time for the subpixels controlled by G2 is 1H, a charging time for the subpixels controlled by G3 is 2H, and a data signal provided to a pixel in a case that the charging time for the subpixels controlled by G2 is 1H is the same as a data signal provided to the pixel in a case that the charging time for the subpixels controlled by G3 is 2H. A charging time for the subpixels controlled by G5 is 1H, a charging time for the subpixels controlled by G8 is 2H, and a data signal provided to a pixel in a case that the charging time for the subpixels controlled by G5 is 1H is the same as a data signal provided to the pixel in a case that the charging time for the subpixels controlled by G8 is 2H. A charging time for the subpixels controlled by G6 is 1H, a charging time for the subpixels controlled by G7 is 2H, and a data signal provided to a pixel in a case that the charging time for the subpixels controlled by G6 is 1H is the same as a data signal provided to the pixel in a case that the charging time for the subpixels controlled by G7 is 2H.

In at least one embodiment of the present disclosure, subpixels in a (3a−2)^{th} column have a first color, subpixels in a (3a−1)^{th} column have a second color, and subpixels in a (3a)^{th} column have a third color, where a is a positive integer; subpixels in a (4m−2)^{th} row and odd-numbered columns are electrically coupled to an (8m−4)^{th} scanning line, and subpixels in the (4m−2)^{th} row and even-numbered columns are electrically coupled to an (8m−3)^{th} scanning line; subpixels in a (4m−1)^{th} row and the odd-numbered columns are electrically coupled to an (8m−3)^{th} scanning line, and subpixels in the (4m−1)^{th} row and the even-numbered columns are electrically coupled to an (8m−2)^{th} scanning line; subpixels in a (4m)^{th} row and the odd-numbered columns are electrically coupled to an (8m−1)^{th} scanning line, and subpixels in the (4m)^{th} row and the even-numbered columns are electrically coupled to an (8m)^{th} scanning line; and subpixels in a (4m−1)^{th} row and the odd-numbered columns are electrically coupled to an (8m+2)^{th} scanning line, and subpixels in the (4m+1)^{th} row and the even-numbered columns are electrically coupled to an (8m+1)^{th} scanning line, where a and m are both positive integers.

In a possible embodiment of the present disclosure, a subpixel in the (4m−2)^{th} row and a (2b−1)^{th} column, a subpixel in the (4m−2)^{th} row and a (2b)^{th} column, a subpixel in the (4m−1)^{th} row and the (2b−1)^{th} column and a subpixel in the (4m−1)^{th} row and the (2b)^{th} column are electrically coupled to a b^{th} data line; and a subpixel in the (4m)^{th} row and the (2b−1)^{th} column, a subpixel in the (4m)^{th} row and the (2b)^{th} column, a subpixel in the (4m+1)^{th} row and the (2b−1)^{th} column and a subpixel in the (4m+1)^{th} row and the (2b)^{th} column are electrically coupled to a (b+1)^{th} data line, where b is a positive integer.

In a possible embodiment of the present disclosure, subpixels in a first row and the odd-numbered columns are electrically coupled to a second scanning line, subpixels in the first row and the even-numbered columns are electrically coupled to a first scanning line, and a subpixel in the first row and the (2b−1)^{th} column and a subpixel in the first row and the (2b)^{th} column are both electrically coupled to the (b+1)^{th} data line.

In at least one embodiment of the present disclosure, an (8n−7)^{th}-level driving circuit of the driving module is electrically coupled to a first clock signal line, and configured to generate an (8n−7)^{th} scanning signal according to a first clock signal provided by the first clock signal line; an (8n−6)^{th}-level driving circuit of the driving module is electrically coupled to a second clock signal line, and configured to generate an (8n−6)^{th} scanning signal according to a second clock signal provided by the second clock signal line; an (8n−5)^{th} -level driving circuit of the driving module is electrically coupled to a third clock signal line, and configured to generate an (8n−5)^{th} scanning signal according to a third clock signal provided by the third clock signal line; an (8n−4)^{th}-level driving circuit of the driving module is electrically coupled to a fourth clock signal line, and configured to generate an (8n−4)^{th} scanning signal according to a fourth clock signal provided by the fourth clock signal line; an (8n−3)^{th}-level driving circuit of the driving module is electrically coupled to a fifth clock signal line, and configured to generate an (8n−3)^{th} scanning signal according to a fifth clock signal provided by the fifth clock signal line; an (8n−2)^{th} -level driving circuit of the driving module is electrically coupled to a sixth clock signal line, and configured to generate an (8n−2)^{th} scanning signal according to a sixth clock signal provided by the sixth clock signal line; an (8n−1)^{th}-level driving circuit of the driving module is electrically coupled to a seventh clock signal line, and configured to generate an (8n−1)^{th} scanning signal according to a seventh clock signal provided by the seventh clock signal line; an (8n)^{th}-level driving circuit of the driving module is electrically coupled to an eighth clock signal line, and configured to generate an (8n)^{th} scanning signal according to an eighth clock signal provided by the eighth clock signal line, where n is a positive integer.

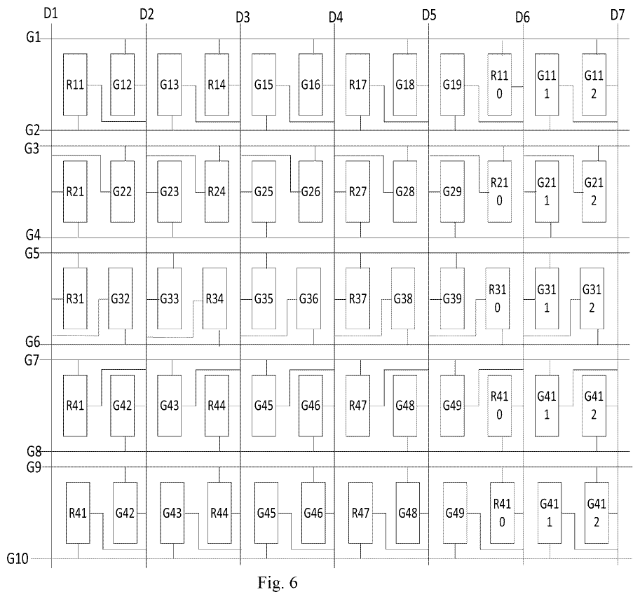

As shown in FIG. 6, the array substrate in at least one embodiment of the present disclosure includes a first scanning line G1, a second scanning line G2, a third scanning line G3, a fourth scanning line G4, a fifth scanning line G5, a sixth scanning line G6, a seventh scanning line G7, an eighth scanning line G8, a ninth scanning line G9, a tenth scanning line G10, a first data line D1, a second data line D2, a third data line D3, a fourth data line D4, a fifth data line D5, a sixth data line Do, and a seventh data line D7.

The array substrate in at least one embodiment of the present disclosure further includes a red subpixel R11 in a first row and a first column, a green subpixel G12 in the first row and a second column, a blue subpixel B13 in the first row and a third column, a red subpixel R14 in the first row and a fourth column, a green subpixel G15 in the first row and a fifth column, a blue subpixel B16 in the first row and a sixth column, a red subpixel R17 in the first row and a seventh column, a green subpixel G18 in the first row and an eighth column, a blue subpixel B19 in the first row and a ninth column, a red subpixel R110 in the first row and a tenth column, a green subpixel G111 in the first row and an eleventh column, a blue subpixel B112 in the first row and a twelfth column, a red subpixel R21 in a second row and the first column, a green subpixel G22 in the second row and the second column, a blue subpixel B23 in the second row and the third column, a red subpixel R24 in the second row and the fourth column, a green subpixel G25 in the second row and the fifth column, a blue subpixel B26 in the second row and the sixth column, a red subpixel R27 in the second row and the seventh column, a green subpixel G28 in the second row and the eighth column, a blue subpixel B29 in the second row and the ninth column, a red subpixel R210 in the second row and the tenth column, a green subpixel G211 in the second row and the eleventh column, a blue subpixel B212 in the second row and the twelfth column, a red subpixel R31 in a third row and the first column, a green subpixel G32 in the third row and the second column, a blue subpixel B33 in the third row and the third column, a red subpixel R34 in the third row and the fourth column, a green subpixel G35 in the third row and the fifth column, a blue subpixel B36 in the third row and the sixth column, a red subpixel R37 in the third row and the seventh column, a green subpixel G38 in the third row and the eighth column, a blue subpixel B39 in the third row and the ninth column, a red subpixel R310 in the third row and the tenth column, a green subpixel G311 in the third row and the eleventh column, a blue subpixel B312 in the third row and the twelfth column, a red subpixel R41 in a fourth row and the first column, a green subpixel G42 in the fourth row and the second column, a blue subpixel B43 in the fourth row and the third column, a red subpixel R44 in the fourth row and the fourth column. a green subpixel G45 in the fourth row and the fifth column, a blue subpixel B46 in the fourth row and the sixth column, a red subpixel R47 in the fourth row and the seventh column, a green subpixel G48 in the fourth row and the eighth column, a blue subpixel B49 in the fourth row and the ninth column, a red subpixel R410 in the fourth row and the tenth column, a green subpixel G411 in the fourth row and the eleventh column, a blue subpixel B412 in the fourth row and the twelfth column, a red subpixel R51 in a fifth row and the first column, a green subpixel G52 in the fifth row and the second column, a blue subpixel B53 in the fifth row and the third column, a red subpixel R54 in the fifth row and the fourth column, a green subpixel G55 in the fifth row and the fifth column, a blue subpixel B56 in the fifth row and the sixth column, a red subpixel R57 in the fifth row and the seventh column, a green subpixel G58 in the fifth row and the eighth column, a blue subpixel B59 in the fifth row and the ninth column, a red subpixel R510 in the fifth row and the tenth column, a green subpixel G511 in the fifth row and the eleventh column, and a blue subpixel B512 in the fifth row and the twelfth column.

R11 is electrically coupled to G2 and D2, and G12 is electrically coupled to G1 and D2; B13 is electrically coupled to G2 and D3, and R14 is electrically coupled to G1 and D3; G15 is electrically coupled to G2 and D4, and B16 is electrically coupled to G1 and D3; R17 is electrically coupled to G2 and D5, and G18 is electrically coupled to G1 and D5; B19 is electrically coupled to G2 and D6, and R110 is electrically coupled to G1 and D6; G11 is electrically coupled to G2 and D7, and B112 is electrically coupled to G1 and D7; R21 is electrically coupled to G4 and D1, and G22 is electrically coupled to G3 and D1; B23 is electrically coupled to G4 and D2, and R24 is electrically coupled to G3 and D2; G25 is electrically coupled to G4 and D3, and B26 is electrically coupled to G3 and D3; R27 is electrically coupled to G4 and D4, and G28 is electrically coupled to G3 and D4; B29 is electrically coupled to G4 and D5, and R210 is electrically coupled to G3 and D5; G211 is electrically coupled to G4 and D6, and B212 is electrically coupled to G3 and D6; R31 is electrically coupled to G5 and D1, G32 is electrically coupled to G6 and D1; B33 is electrically coupled to G5 and D23, and R34 is electrically coupled to G6 and D2; G35 is electrically coupled to G5 and D3, and B36 is electrically coupled to G6 and D3; R37 is electrically coupled to G5 and D4, and G38 is electrically coupled to G6 and D4; B39 is electrically coupled to G5 and D5, and R310 is electrically coupled to G6 and D5; G311 is electrically coupled to G5 and D6, and B312 is electrically coupled to G6 and D6; R41 is electrically coupled to G7 and D2, and G32 is electrically coupled to G8 and D2; B43 is electrically coupled to G7 and D3, and R44 is electrically coupled to G8 and D3; G45 is electrically coupled to G7 and D4, and B46 is electrically coupled to G8 and D4; R47 is electrically coupled to G7 and D5, and G48 is electrically coupled to G8 and D5; B49 is electrically coupled to G7 and D6, and R410 is electrically coupled to G8 and D6; G411 is electrically coupled to G7 and D7, and R412 is electrically coupled to G8 and D7; R51 is electrically coupled to G10 and D2, and G52 is electrically coupled to G9 and D2; B53 is electrically coupled to G10 and D3, and R54 is electrically coupled to G9 and D3; G55 is electrically coupled to G10 and D4, and B56 is electrically coupled to G10 and D4; R57 is electrically coupled to G10 and D5, and G58 is electrically coupled to G9 and D5; B59 is electrically coupled to G10 and D6, and R510 is electrically coupled to G9 and D6; and G511 is electrically coupled to G10 and D7, and R512 is electrically coupled to G9 and D7.

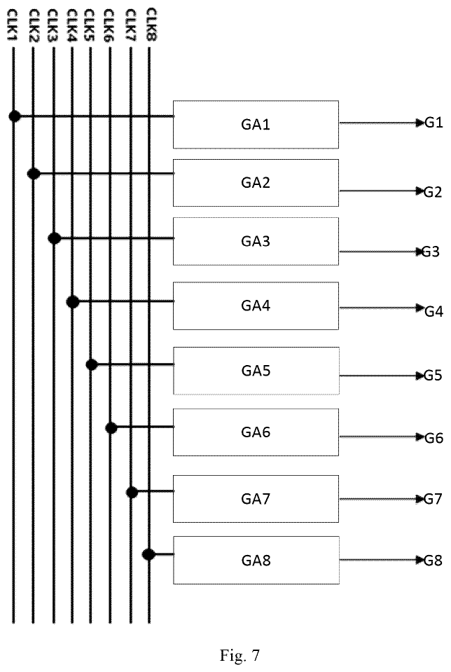

As shown in FIG. 7, the driving module includes a first-level driving circuit GAI, a second-level driving circuit GA2, a third-level driving circuit GA3, a fourth-level driving circuit GA4, a fifth-level driving circuit GA5, a sixth-level driving circuit GA6, a seventh-level driving circuit GA7 and an eighth-level driving circuit GA8. The driving module in FIG. 7 provides the scanning signal for the pixel structure in FIG. 6.

GAI is electrically coupled to a first clock signal line CLK1, and configured to generate a first scanning signal according to a first clock signal provided by the first clock signal line CLK1, and provide the first scanning signal to the first scanning line G1. GA2 is electrically coupled to a second clock signal line CLK2, and configured to generate a second scanning signal according to a second clock signal provided by the second clock signal line CLK2, and provide the second scanning signal to the second scanning line G2. GA3 is electrically coupled to a third clock signal line CLK3, and configured to generate a third scanning signal according to a third clock signal provided by the third clock signal line CLK3, and provide the third scanning signal to the second scanning line G3. GA4 is electrically coupled to a fourth clock signal line CLK4, and configured to generate a fourth scanning signal according to a fourth clock signal provided by the fourth clock signal line CLK4, and provide the fourth scanning signal to the fourth scanning line G4. GA5 is electrically coupled to a fifth clock signal line CLK5, and configured to generate a fifth scanning signal according to a fifth clock signal provided by the fifth clock signal line CLK5, and provide the fifth scanning signal to the fifth scanning line G5. GA6 is electrically coupled to a sixth clock signal line CLK6, and configured to generate a sixth scanning signal according to a sixth clock signal provided by the sixth clock signal line CLK6, and provide the sixth scanning signal to the sixth scanning line G6. GA7 is electrically coupled to a seventh clock signal line CLK7, and configured to generate a seventh scanning signal according to a seventh clock signal provided by the seventh clock signal line CLK7, and provide the seventh scanning signal to the seventh scanning line G7. GAS is electrically coupled to an eighth clock signal line CLK8, and configured to generate an eighth scanning signal according to an eighth clock signal provided by the eighth clock signal line CLK8, and provide the eighth scanning signal to the eighth scanning line G8.

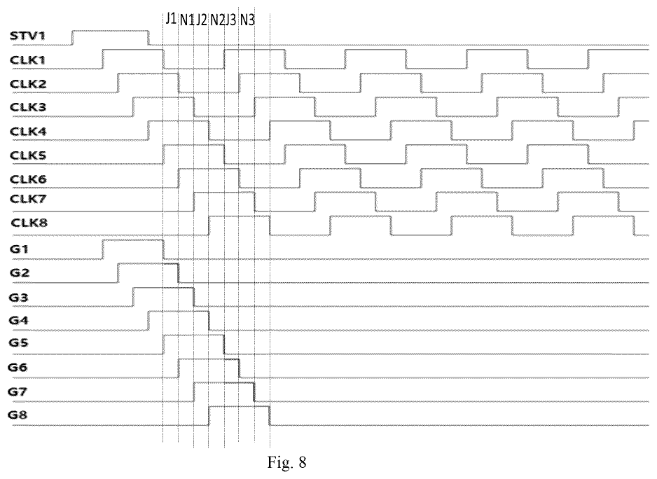

FIG. 8 is a sequence diagram of the signals in FIG. 7.

In FIG. 8, STV represents a start signal received by G1.

As shown in FIG. 8, a duty ratio of the first clock signal, a duty ratio of the second clock signal, a duty ratio of the third clock signal, a duty ratio of the fourth clock signal, a duty ratio of the fifth clock signal, a duty ratio of the sixth clock signal, a duty ratio of the seventh clock signal and a duty ratio of the eighth clock signal are all ½. A period of the first clock signal, a period of the second clock signal, a period of the third clock signal, a period of the fourth clock signal, a period of the fifth clock signal, a period of the sixth clock signal, a period of the seventh clock signal and a period of the eighth clock signal are all T. The second clock signal is delayed relative to the first clock signal by T/8, the third cock signal is delayed relative to the second clock signal by T/8, the fourth clock signal is delayed relative to the third clock signal by T/8, the fifth clock signal is delayed relative to the fourth clock signal by T/8, the sixth clock signal is delayed relative to the fifth clock signal by T/8, the seventh clock signal is delayed relative to the sixth clock signal by T/8, and the eighth clock signal is delayed relative to the seventh clock signal by T/8.

During the operation of the driving module in FIG. 8, G1, G2, G3, G4, G5, G6, G7 and G8 are enabled sequentially. A first overlapping time period J1 and a first non-overlapping time period N1 are included between an active time period of the second scanning signal provided by G2 and an active time period of the third scanning signal provided by G3. A second overlapping time period J2 and a second non-overlapping time period N2 are included between an active time period of the fourth scanning signal provided by G4 and an active time period of the fifth scanning signal provided by G5. A third overlapping time period J3 and a third non-overlapping time period N3 are included between an active time period of the sixth scanning signal provided by G6 and an active time period of the seventh scanning signal provided by G7.

A data voltage received by the data line within at least part of the first overlapping time period J1 is the same as a data voltage received by the data line within at least part of the first non-overlapping time period N1. A data voltage received by the data line within at least part of the second overlapping time period J2 is the same as a data voltage received by the data line within at least part of the second non-overlapping time period N2. A data voltage received by the data line within at least part of the third overlapping time period J3 is the same as a data voltage received by the data line within at least part of the third non-overlapping time period N3.

In a possible embodiment of the present disclosure, the data voltage received within the overlapping time period is the same as that received within the non-overlapping time period. For example, the data voltage received within the first overlapping time period J1 is the same as the data voltage received within the first non-overlapping time period N1, the data voltage received within the second overlapping time period J2 is the same as the data voltage received within the second non-overlapping time period N2, the data voltage received within the third overlapping time period J3 is the same as the data voltage received within the third non-overlapping time period N3, and so on.

During the operation of the driving module in FIG. 7, the HSR mode is not activated for the subpixels in the first row, a charging time for the subpixels in the first row is 1H, i.e., a time for charging the subpixels electrically coupled to G1 via transistors is 1H. However, the present disclosure is not limited thereto. During the implementation, the charging time for the subpixels in the first row may also be 2H.

During the operation of the driving module in FIG. 7, the HSR mode is activated for the subpixels in the rows other than the first row.

As shown in FIG. 8, a charging time for the subpixels controlled by G1 is 1H (a charging time for one row), a charging time for the subpixels controlled by G2 is 1H, a charging time for the subpixels controlled by G3 is 2H, and a data signal provided to a pixel in a case that the charging time for the subpixels controlled by G2 is 1H is the same as a data signal provided to the pixel in a case that the charging time for the subpixels controlled by G3 is 2H. A charging time for the subpixels controlled by G4 is 1H, a charging time for the subpixels controlled by G5 is 2H, and a data signal provided to a pixel in a case that the charging time for the subpixels controlled by G4 is 1H is the same as a data signal provided to the pixel in a case that the charging time for the subpixels controlled by G5 is 2H. A charging time for the subpixels controlled by G6 is 1H, a charging time for the subpixels controlled by G7 is 2H, a charging time for the subpixels controlled by G8 is 1H, and a data signal provided to a pixel in a case that the charging time for the subpixels controlled by G6 is 1H is the same as a data signal provided to the pixel in a case that the charging time for the subpixels controlled by G7 is 2H.

The present disclosure further provides in some embodiments a driving method for the above-mentioned array substrate, including: receiving, by a subpixel, a data voltage provided by a data line under the control of a scanning signal provided by a scanning line; and providing, by a driving module, the scanning signal to the scanning line to control, within a display frame, that an overlapping time period and a non-overlapping time period are included between active time periods of the scanning signals provided by at least two scanning lines enabled sequentially. The data voltage received by the data line within at least part of the overlapping time period is the same as the data voltage received by the data line within at least part of the non-overlapping time period.

In at least one embodiment of the present disclosure, subpixels in a (3a−2)^{th} column have a first color, subpixels in a (3a−1)^{th} column have a second color, and subpixels in a (3a)^{th} column have a third color, where a is a positive integer; subpixels in a (4m−3)^{th} row and odd-numbered columns are electrically coupled to an (8m−7)^{th} scanning line, and subpixels in the (4m−3)^{th} row and even-numbered columns are electrically coupled to an (8m−6)^{th} scanning line; subpixels in a (4m−2)^{th} row and the odd-numbered columns are electrically coupled to an (8m−4)^{th} scanning line, and subpixels in the (4m−2)^{th} row and the even-numbered columns are electrically coupled to an (8m−5)^{th} scanning line; subpixels in a (4m−1)^{th} row and the odd-numbered columns are electrically coupled to an (8m−2)^{th} scanning line, and subpixels in the (4m−1)^{th} row and the even-numbered columns are electrically coupled to an (8m−3)^{th} scanning line; and subpixels in a (4m)^{th} row and the odd-numbered columns are electrically coupled to an (8m−1)^{th} scanning line, and subpixels in the (4m)^{th} row and the even-numbered columns are electrically coupled to an (8m)^{th} scanning line, where a and m are both positive integers; a subpixel in the (4m−3)^{th} row and a (2b−1)^{th} column, a subpixel in the (4m−2)^{th} row and the (2b−1)^{th} column, a subpixel in the (4m−3)^{th} row and a (2b)^{th} column and a subpixel in the (4m−2)^{th} row and the (2b)^{th} column are electrically coupled to a b^{th} data line; and a subpixel in the (4m−1)^{th} row and the (2b−1)^{th} column, a subpixel in the (4m−1)^{th} row and the (2b)^{th} column, a subpixel in the (4m)^{th} row and the (2b−1)^{th} column and a subpixel in the (4m)^{th} row and the (2b)^{th} column are electrically coupled to a (b+1)^{th} data line, where b is a positive integer. The driving method includes: controlling, by the driving module, an (8n−2)^{th} scanning line and an (8n−4)^{th} scanning line to be enabled sequentially, to control, within a subframe, that an overlapping time period and a non-overlapping time period are included in an active time period of an (8n−7)^{th} scanning signal and an active time period of an (8n−4)^{th} scanning signal; controlling, by the driving module, an (8n−6)^{th} scanning line and an (8n−5)^{th} scanning line to be enabled sequentially, to control, within a subframe, that an overlapping time period and a non-overlapping time period are included in an active time period of an (8n−6)^{th} scanning signal and an active time period of an (8n−5)^{th} scanning signal; controlling, by the driving module, an (8n−3)^{th} scanning line and an (8n)^{th} scanning line to be enabled sequentially, to control, within a subframe, that an overlapping time period and a non-overlapping time period are included in an active time period of an (8n−3)^{th} scanning signal and an active time period of an (8n)^{th} scanning signal; and controlling, by the driving module, an (8n−2)^{th} scanning line and an (8n−2)^{th} scanning line to be enabled sequentially, to control, within a subframe, that an overlapping time period and a non-overlapping time period are included in an active time period of an (8n−2)^{th} scanning signal and an active time period of an (8n−1)^{th} scanning signal, where n is a positive integer.

In at least one embodiment of the present disclosure, subpixels in a (3a−2)^{th} column have a first color, subpixels in a (3a−1)^{th} column have a second color, and subpixels in a (3a)^{th} column have a third color, where a is a positive integer; subpixels in a (4m−2)^{th} row and odd-numbered columns are electrically coupled to an (8m−4)^{th} scanning line, and subpixels in the (4m−2)^{th} row and even-numbered columns are electrically coupled to an (8m−3)^{th} scanning line; subpixels in a (4m−1)^{th} row and the odd-numbered columns are electrically coupled to an (8m−3)^{th} scanning line, and subpixels in the (4m−1)^{th} row and the even-numbered columns are electrically coupled to an (8m−2)^{th} scanning line; subpixels in a (4m)^{th} row and the odd-numbered columns are electrically coupled to an (8m−1)^{th} scanning line, and subpixels in the (4m)^{th} row and the even-numbered columns are electrically coupled to an (8m)^{th} scanning line; and subpixels in a (4m+1)^{th} row and the odd-numbered columns are electrically coupled to an (8m+2)^{th} scanning line, and subpixels in the (4m+1)^{th} row and the even-numbered columns are electrically coupled to an (8m+1)^{th} scanning line, where a and m are both positive integers; a subpixel in the (4m−2)^{th} row and a (2b−1)^{th} column, a subpixel in the (4m−2)^{th} row and a (2b)^{th} column, a subpixel in the (4m−1)^{th} row and the (2b−1)^{th} column and a subpixel in the (4m−1)^{th} row and the (2b)^{th} column are electrically coupled to a b^{th} data line; and a subpixel in the (4m)^{th} row and the (2b−1)^{th} column, a subpixel in the (4m) row and the (2b)^{th} column, a subpixel in the (4m+1)^{th} row and the (2b−1)^{th} column and a subpixel in the (4m+1)^{th} row and the (2b)^{th} column are electrically coupled to a (b+1)^{th} data line, where b is a positive integer. The driving method includes: controlling, by the driving module, an (8n−6)^{th} scanning line and an (8n−5)^{th} scanning line to be enabled sequentially, to control, within a subframe, that an overlapping time period and a non-overlapping time period are included in an active time period of an (8n−6)^{th} scanning signal and an active time period of an (8n−5)^{th} scanning signal; controlling, by the driving module, an (8n−4)^{th} scanning line and an (8n−3)^{th} scanning line to be enabled sequentially, to control, within a subframe, that an overlapping time period and a non-overlapping time period are included in an active time period of an (8n−4)^{th} scanning signal and an active time period of an (8n−3)^{th} scanning signal; controlling, by the driving module, an (8n−2)^{th} scanning line and an (8n−1)^{th} scanning line to be enabled sequentially, to control, within a subframe, that an overlapping time period and a non-overlapping time period are included in an active time period of an (8n−2)^{th} scanning signal and an active time period of an (8n−1)^{th} scanning signal; and controlling, by the driving module, an (8n)^{th} scanning line and an (8n+1)^{th} scanning line to be enabled sequentially, to control, within a subframe, that an overlapping time period and a non-overlapping time period are included in an active time period of an (8n)^{th} scanning signal and an active time period of an (8n+1)^{th} scanning signal, where n is a positive integer.

In a possible embodiment of the present disclosure, subpixels in a first row and the odd-numbered column are electrically coupled to a second scanning line, subpixels in the first row and the even-numbered columns are electrically coupled to a first scanning line, and a subpixel in the first row and the (2b−1)^{th} column and a subpixel in the first row and the (2b)^{th} column are both electrically coupled to the (b+1)^{th} data line. The driving method further includes, prior to enabling the second scanning line, controlling, by the driving module, the first scanning line to be enabled, and no overlapping time period is included between an active time period of a first scanning signal provided by the first scanning line and an active time period of a scanning signal provided by the other scanning line.

The present disclosure further provides in some embodiments a display device including the above-mentioned array substrate.

The above are merely the embodiments of the present disclosure. It should be noted that, a person skilled in the art may further make improvements and modifications without departing from the principle of the present disclosure, and these improvements and modifications shall also fall within the scope of the present disclosure.

1. An array substrate, comprising a driving module, a plurality of scanning lines extending in a first direction, a plurality of data lines extending in a second direction, and a plurality of pixels;
wherein the pixel comprises at least three subpixels having different colors, two scanning lines are arranged between two adjacent rows of subpixels, two columns of subpixels are arranged between two data lines, and the subpixel is electrically coupled to the data line and configured to receive a data voltage provided by the data line under the control of a scanning signal provided by the scanning line;
in a same row of subpixels, the subpixels electrically coupled to a same data line have at least two colors;
in adjacent rows of subpixels, at least two subpixels electrically coupled to a same data line have a same color;
the driving module is configured to provide the scanning signal to the scanning line to control, within a display frame, that an overlapping time period and a non-overlapping time period are comprised between active time periods of the scanning signals provided by at least two scanning lines enabled sequentially; and
the data voltage received by the data line within at least part of the overlapping time period is the same as the data voltage received by the data line within at least part of the non-overlapping time period.

2. The array substrate according to claim 1, wherein subpixels in a (3a−2)^{th} column have a first color, subpixels in a (3a−1)^{th} column have a second color, and subpixels in a (3a)^{th} column have a third color;
subpixels in a (4m−3)^{th} row and odd-numbered columns are electrically coupled to an (8m−7)^{th} scanning line, and subpixels in the (4m−3)^{th} row and even-numbered columns are electrically coupled to an (8m−6)^{th} scanning line;
subpixels in a (4m−2)^{th} row and the odd-numbered columns are electrically coupled to an (8m−4)^{th} scanning line, and subpixels in the (4m−2)^{th} row and the even-numbered columns are electrically coupled to an (8m−5)^{th} scanning line;
subpixels in a (4m−1)^{th} row and the odd-numbered columns are electrically coupled to an (8m−2)^{th} scanning line, and subpixels in the (4m−1)^{th} row and the even-numbered columns are electrically coupled to an (8m−3)^{th} scanning line; and
subpixels in a (4m)a row and the odd-numbered columns are electrically coupled to an (8m−1)^{th} scanning line, and subpixels in the (4m)^{th} row and the even-numbered columns are electrically coupled to an (8m)^{th} scanning line, where a and m are both positive integers.

3. The array substrate according to claim 2, wherein a subpixel in the (4m−3)^{th} row and a (2b−1)^{th} column, a subpixel in the (4m−2)^{th} row and the (2b−1)^{th} column, a subpixel in the (4m−3)^{th} row and a (2b)^{th} column and a subpixel in the (4m−2)^{th} row and the (2b)^{th} column are electrically coupled to a b^{th} data line; and
a subpixel in the (4m−1)^{th} row and the (2b−1)^{th} column, a subpixel in the (4m−1)^{th} row and the (2b)^{th} column, a subpixel in the (4m)^{th} row and the (2b−1)^{th} column and a subpixel in the (4m)^{th} row and the (2b)^{th} column are electrically coupled to a (b+1)^{th} data line, where b is a positive integer.

4. The array substrate according to claim 3, wherein an (8n−7)^{th}-level driving circuit of the driving module is electrically coupled to a first clock signal line, and configured to generate an (8n−7)^{th} scanning signal according to a first clock signal provided by the first clock signal line;
an (8n−6)^{th}-level driving circuit of the driving module is electrically coupled to a second clock signal line, and configured to generate an (8n−4)^{th} scanning signal according to a second clock signal provided by the second clock signal line;
an (8n−5)^{th}-level driving circuit of the driving module is electrically coupled to a third clock signal line, and configured to generate an (8n−6)^{th} scanning signal according to a third clock signal provided by the third clock signal line;
an (8n−4)^{th}-level driving circuit of the driving module is electrically coupled to a fourth clock signal line, and configured to generate an (8n−5)^{th} scanning signal according to a fourth clock signal provided by the fourth clock signal line;
an (8n−3)^{th}-level driving circuit of the driving module is electrically coupled to a fifth clock signal line, and configured to generate an (8n−5)^{th} scanning signal according to a fifth clock signal provided by the fifth clock signal line;
an (8n−2)^{th}-level driving circuit of the driving module is electrically coupled to a sixth clock signal line, and configured to generate an (8n)^{th} scanning signal according to a sixth clock signal provided by the sixth clock signal line;
an (8n−1)^{th}-level driving circuit of the driving module is electrically coupled to a seventh clock signal line, and configured to generate an (8n−2)^{th} scanning signal according to a seventh clock signal provided by the seventh clock signal line; and
an (8n)^{th}-level driving circuit of the driving module is electrically coupled to an eighth clock signal line, and configured to generate an (8n−1)^{th} scanning signal according to an eighth clock signal provided by the eighth clock signal line, where n is a positive integer.

5. The array substrate according to claim 3, wherein an (8n−7)^{th}-level driving circuit of the driving module is electrically coupled to a first clock signal line, and configured to generate an (8n−7)^{th} scanning signal according to a first clock signal provided by the first clock signal line;
an (8n−6)^{th}-level driving circuit of the driving module is electrically coupled to a third clock signal line, and configured to generate an (8n−6)^{th} scanning signal according to a third clock signal provided by the third clock signal line;
an (8n−5)^{th}-level driving circuit of the driving module is electrically coupled to a fourth clock signal line, and configured to generate an (8n−5)^{th} scanning signal according to a fourth clock signal provided by the fourth clock signal line;
an (8n−4)^{th}-level driving circuit of the driving module is electrically coupled to a second clock signal line, and configured to generate an (8n−4)^{th} scanning signal according to a second clock signal provided by the second clock signal line;
an (8n−3)^{th}-level driving circuit of the driving module is electrically coupled to a fifth clock signal line, and configured to generate an (8n−3)^{th} scanning signal according to a fifth clock signal provided by the fifth clock signal line:
an (8n−2)^{th}-level driving circuit of the driving module is electrically coupled to a seventh clock signal line, and configured to generate an (8n−2)^{th} scanning signal according to a seventh clock signal provided by the seventh clock signal line;
an (8n−1)^{th}-level driving circuit of the driving module is electrically coupled to an eighth clock signal line, and configured to generate an (8n−1)^{th} scanning signal according to an eighth clock signal provided by the eighth clock signal line; and
an (8n)^{th}-level driving circuit of the driving module is electrically coupled to a sixth clock signal line, and configured to generate an (8n)^{th} scanning signal according to a sixth clock signal provided by the sixth clock signal line, where n is a positive integer.

6. The array substrate according to claim 1, wherein subpixels in a (3a−2)^{th} column have a first color, subpixels in a (3a−1)^{th} column have a second color, and subpixels in a (3a)^{th} column have a third color;
subpixels in a (4m−2)^{th} row and odd-numbered columns are electrically coupled to an (8m−4)^{th} scanning line, and subpixels in the (4m−2)^{th} row and even-numbered columns are electrically coupled to an (8m−3)^{th} scanning line;
subpixels in a (4m−1)^{th} row and the odd-numbered columns are electrically coupled to an (8m−3)^{th} scanning line, and subpixels in the (4m−1)^{th} row and the even-numbered columns are electrically coupled to an (8m−2)^{th} scanning line;
subpixels in a (4m)^{th} row and the odd-numbered columns are electrically coupled to an (8m−1)^{th} scanning line, and subpixels in the (4m)^{th} row and the even-numbered columns are electrically coupled to an (8m)^{th} scanning line; and
subpixels in a (4m+1)^{th} row and the odd-numbered columns are electrically coupled to an (8m+2)^{th} scanning line, and subpixels in the (4m+1)^{th} row and the even-numbered columns are electrically coupled to an (8m+1)^{th} scanning line, where a and m are both positive integers.

7. The array substrate according to claim 6, wherein a subpixel in the (4m−2)^{th} row and a (2b−1)^{th} column, a subpixel in the (4m−2)^{th} row and a (2b)^{th} column, a subpixel in the (4m−1)^{th} row and the (2b−1)^{th} column and a subpixel in the (4m−1)^{th} row and the (2b)^{th} column are electrically coupled to a b^{th} data line; and
a subpixel in the (4m)^{th} row and the (2b−1)^{th} column, a subpixel in the (4m)^{th} row and the (2b)^{th} column, a subpixel in the (4m+1)^{th} row and the (2b−1)^{th} column and a subpixel in the (4m+1)^{th} row and the (2b)^{th} column are electrically coupled to a (b+1)^{th} data line, where b is a positive integer.

8. The array substrate according to claim 7, wherein subpixels in a first row and the odd-numbered columns are electrically coupled to a second scanning line, subpixels in the first row and the even-numbered columns are electrically coupled to a first scanning line, and a subpixel in the first row and the (2b−1)^{th} column and a subpixel in the first row and the (2b)^{th} column are both electrically coupled to the (b+1)^{th} data line.

9. The array substrate according to claim 8, wherein an (8n−7)^{th}-level driving circuit of the driving module is electrically coupled to a first clock signal line, and configured to generate an (8n−7)^{th} scanning signal according to a first clock signal provided by the first clock signal line;
an (8n−6)^{th}-level driving circuit of the driving module is electrically coupled to a second clock signal line, and configured to generate an (8n−6)^{th} scanning signal according to a second clock signal provided by the second clock signal line;
an (8n−5)^{th}-level driving circuit of the driving module is electrically coupled to a third clock signal line, and configured to generate an (8n−5)^{th} scanning signal according to a third clock signal provided by the third clock signal line;
an (8n−4)^{th}-level driving circuit of the driving module is electrically coupled to a fourth clock signal line, and configured to generate an (8n−4)^{th} scanning signal according to a fourth clock signal provided by the fourth clock signal line;
an (8n−3)^{th}-level driving circuit of the driving module is electrically coupled to a fifth clock signal line, and configured to generate an (8n−3)^{th} scanning signal according to a fifth clock signal provided by the fifth clock signal line;
an (8n−2)^{th}-level driving circuit of the driving module is electrically coupled to a sixth clock signal line, and configured to generate an (8n−2)^{th} scanning signal according to a sixth clock signal provided by the sixth clock signal line;
an (8n−1)^{th} -level driving circuit of the driving module is electrically coupled to a seventh clock signal line, and configured to generate an (8n−1)^{th} scanning signal according to a seventh clock signal provided by the seventh clock signal line; and
an (8n)^{th}-level driving circuit of the driving module is electrically coupled to an eighth clock signal line, and configured to generate an (8n)^{th} scanning signal according to an eighth clock signal provided by the eighth clock signal line, where n is a positive integer.

10. A driving method, applied to the array substrate according to claim 1, comprising:
receiving, by a subpixel, a data voltage provided by a data line under the control of a scanning signal provided by a scanning line; and
providing, by a driving module, the scanning signal to the scanning line to control, within a display frame, that an overlapping time period and a non-overlapping time period are comprised between active time periods of the scanning signals provided by at least two scanning lines enabled sequentially,
wherein the data voltage received by the data line within at least part of the overlapping time period is the same as the data voltage received by the data line within at least part of the non-overlapping time period.

11. The driving method according to claim 10, wherein subpixels in a (3a−2)^{th} column have a first color, subpixels in a (3a−1)^{th} column have a second color, and subpixels in a (3a)^{th} column have a third color; subpixels in a (4m−3)^{th} row and odd-numbered columns are electrically coupled to an (8m−7)^{th} scanning line, and subpixels in the (4m−3)^{th} row and even-numbered columns are electrically coupled to an (8m−6)^{th} scanning line; subpixels in a (4m−2)^{th} row and the odd-numbered columns are electrically coupled to an (8m−4)^{th} scanning line, and subpixels in the (4m−2)^{th} row and the even-numbered columns are electrically coupled to an (8m−5)^{th} scanning line; subpixels in a (4m−1)^{th} row and the odd-numbered columns are electrically coupled to an (8m−2)^{th} scanning line, and subpixels in the (4m−1)^{th} row and the even-numbered columns are electrically coupled to an (8m−3)^{th} scanning line; and subpixels in a (4m)^{th} row and the odd-numbered columns are electrically coupled to an (8m−1)^{th} scanning line, and subpixels in the (4m)^{th} row and the even-numbered columns are electrically coupled to an (8m)^{th} scanning line, where a and m are both positive integers; a subpixel in the (4m−3)^{th} row and a (2b−1)^{th} column, a subpixel in the (4m−2)^{th} row and the (2b−1)^{th} column, a subpixel in the (4m−3)^{th} row and a (2b)^{th} column and a subpixel in the (4m−2)^{th} row and the (2b)^{th} column are electrically coupled to a b^{th} data line; and a subpixel in the (4m−1)^{th} row and the (2b−1)^{th} column, a subpixel in the (4m−1)^{th} row and the (2b)^{th} column, a subpixel in the (4m)^{th} row and the (2b−1)^{th} column and a subpixel in the (4m)^{th} row and the (2b)^{th} column are electrically coupled to a (b+1)^{th} data line, where b is a positive integer;
wherein the driving method comprises:
controlling, by the driving module, an (8n−2)^{th} scanning line and an (8n−4)^{th} scanning line to be enabled sequentially, to control, within a subframe, that an overlapping time period and a non-overlapping time period are comprised in an active time period of an (8n−7)^{th} scanning signal and an active time period of an (8n−4)^{th} scanning signal;
controlling, by the driving module, an (8n−6)^{th} scanning line and an (8n−5)^{th} scanning line to be enabled sequentially, to control, within a subframe, that an overlapping time period and a non-overlapping time period are comprised in an active time period of an (8n−6)^{th} scanning signal and an active time period of an (8n−5)^{th} scanning signal;
controlling, by the driving module, an (8n−3)^{th} scanning line and an (8n)^{th} scanning line to be enabled sequentially, to control, within a subframe, that an overlapping time period and a non-overlapping time period are comprised in an active time period of an (8n−3)^{th} scanning signal and an active time period of an (8n)^{th} scanning signal; and
controlling, by the driving module, an (8n−2)^{th} scanning line and an (8n−2)^{th} scanning line to be enabled sequentially, to control, within a subframe, that an overlapping time period and a non-overlapping time period are comprised in an active time period of an (8n−2)^{th} scanning signal and an active time period of an (8n−1)^{th} scanning signal, where n is a positive integer.

12. The driving method according to claim 10, wherein subpixels in a (3a−2)^{th} column have a first color, subpixels in a (3a−1)^{th} column have a second color, and subpixels in a (3a)^{th} column have a third color; subpixels in a (4m−2)^{th} row and odd-numbered columns are electrically coupled to an (8m−4)^{th} scanning line, and subpixels in the (4m−2)^{th} row and even-numbered columns are electrically coupled to an (8m−3)^{th} scanning line; subpixels in a (4m−1)^{th} row and the odd-numbered columns are electrically coupled to an (8m−3)^{th} scanning line, and subpixels in the (4m−1)^{th} row and the even-numbered columns are electrically coupled to an (8m−2)^{th} scanning line; subpixels in a (4m)^{th} row and the odd-numbered columns are electrically coupled to an (8m−1)^{th} scanning line, and subpixels in the (4m)^{th} row and the even-numbered columns are electrically coupled to an (8m)^{th} scanning line; and subpixels in a (4m+1)^{th} row and the odd-numbered columns are electrically coupled to an (8m+2)^{th} scanning line, and subpixels in the (4m+1)^{th} row and the even-numbered columns are electrically coupled to an (8m+1)^{th} scanning line, where a and m are both positive integers; a subpixel in the (4m−2)^{th} row and a (2b−1)^{th} column, a subpixel in the (4m−2)^{th} row and a (2b)^{th} column, a subpixel in the (4m−1)^{th} row and the (2b−1)^{th} column and a subpixel in the (4m−1)^{th} row and the (2b)^{th} column are electrically coupled to a b)^{th} data line; and a subpixel in the (4m)^{th} row and the (2b−1)^{th} column, a subpixel in the (4m)^{th} row and the (2b)^{th} column, a subpixel in the (4m+1)^{th} row and the (2b−1)^{th} column and a subpixel in the (4m+1)^{th} row and the (2b)^{th} column are electrically coupled to a (b+1)^{th} data line, where b is a positive integer;
wherein the driving method comprises:
controlling, by the driving module, an (8n−6)^{th} scanning line and an (8n−5)^{th} scanning line to be enabled sequentially, to control, within a subframe, that an overlapping time period and a non-overlapping time period are comprised in an active time period of an (8n−6)^{th} scanning signal and an active time period of an (8n−5)^{th} scanning signal;
controlling, by the driving module, an (8n−4)^{th} scanning line and an (8n−3)^{th} scanning line to be enabled sequentially, to control, within a subframe, that an overlapping time period and a non-overlapping time period are comprised in an active time period of an (8n−4)^{th} scanning signal and an active time period of an (8n−3)^{th} scanning signal;
controlling, by the driving module, an (8n−2)^{th} scanning line and an (8n−1)^{th} scanning line to be enabled sequentially, to control, within a subframe, that an overlapping time period and a non-overlapping time period are comprised in an active time period of an (8n−2)^{th} scanning signal and an active time period of an (8n−1)^{th} scanning signal; and
controlling, by the driving module, an (8n)^{th} scanning line and an (8n+1)^{th} scanning line to be enabled sequentially, to control, within a subframe, that an overlapping time period and a non-overlapping time period are comprised in an active time period of an (8n)^{th} scanning signal and an active time period of an (8n+1)^{th} scanning signal, where n is a positive integer.

13. The driving method according to claim 12, wherein subpixels in a first row and the odd-numbered column are electrically coupled to a second scanning line, subpixels in the first row and the even-numbered columns are electrically coupled to a first scanning line, and a subpixel in the first row and the (2b−1)^{th} column and a subpixel in the first row and the (2b)^{th} column are both electrically coupled to the (b+1)^{th} data line,
wherein the driving method further comprises, prior to enabling the second scanning line, controlling, by the driving module, the first scanning line to be enabled, and no overlapping time period is comprised between an active time period of a first scanning signal provided by the first scanning line and an active time period of a scanning signal provided by the other scanning line.

14. A display device, comprising an array substrate, wherein the array substrate comprises a driving module, a plurality of scanning lines extending in a first direction, a plurality of data lines extending in a second direction, and a plurality of pixels;
wherein the pixel comprises at least three subpixels having different colors, two scanning lines are arranged between two adjacent rows of subpixels, two columns of subpixels are arranged between two data lines, and the subpixel is electrically coupled to the data line and configured to receive a data voltage provided by the data line under the control of a scanning signal provided by the scanning line:
in a same row of subpixels, the subpixels electrically coupled to a same data line have at least two colors:
in adjacent rows of subpixels, at least two subpixels electrically coupled to a same data line have a same color:
the driving module is configured to provide the scanning signal to the scanning line to control, within a display frame, that an overlapping time period and a non-overlapping time period are comprised between active time periods of the scanning signals provided by at least two scanning lines enabled sequentially; and
the data voltage received by the data line within at least part of the overlapping time period is the same as the data voltage received by the data line within at least part of the non-overlapping time period.

15. The display device according to claim 14, wherein subpixels in a (3a−2)^{th} column have a first color, subpixels in a (3a−1)^{th} column have a second color, and subpixels in a (3a)^{th} column have a third color;
subpixels in a (4m−3)^{th} row and odd-numbered columns are electrically coupled to an (8m−7)^{th} scanning line, and subpixels in the (4m−3)^{th} row and even-numbered columns are electrically coupled to an (8m−6)^{th} scanning line;
subpixels in a (4m−2)^{th} row and the odd-numbered columns are electrically coupled to an (8m−4)^{th} scanning line, and subpixels in the (4m−2)^{th} row and the even-numbered columns are electrically coupled to an (8m−5)^{th} scanning line;
subpixels in a (4m−1)^{th} row and the odd-numbered columns are electrically coupled to an (8m−2)^{th} scanning line, and subpixels in the (4m−1)^{th} row and the even-numbered columns are electrically coupled to an (8m−3)^{th} scanning line; and
subpixels in a (4m)^{th} row and the odd-numbered columns are electrically coupled to an (8m−1)^{th} scanning line, and subpixels in the (4m)^{th} row and the even-numbered columns are electrically coupled to an (8m)^{th} scanning line, where a and m are both positive integers.

16. The display device according to claim 15, wherein a subpixel in the (4m−3)^{th} row and a (2b−1)^{th} column, a subpixel in the (4m−2)^{th} row and the (2b−1)^{th} column, a subpixel in the (4m−3)^{th} row and a (2b)^{th} column and a subpixel in the (4m−2)^{th} row and the (2b)^{th} column are electrically coupled to a b)^{th} data line; and
a subpixel in the (4m−1)^{th} row and the (2b−1)^{th} column, a subpixel in the (4m−1)^{th} row and the (2b)^{th} column, a subpixel in the (4m)^{th} row and the (2b−1)^{th} column and a subpixel in the (4m)^{th} row and the (2b)^{th} column are electrically coupled to a (b+1)^{th} data line, where b is a positive integer.

17. The display device according to claim 16, wherein an (8n−7)^{th} -level driving circuit of the driving module is electrically coupled to a first clock signal line, and configured to generate an (8n−7)^{th} scanning signal according to a first clock signal provided by the first clock signal line;
an (8n−6)^{th}-level driving circuit of the driving module is electrically coupled to a second clock signal line, and configured to generate an (8n−4)^{th} scanning signal according to a second clock signal provided by the second clock signal line;
an (8n−5)^{th}-level driving circuit of the driving module is electrically coupled to a third clock signal line, and configured to generate an (8n−6)^{th} scanning signal according to a third clock signal provided by the third clock signal line;
an (8n−4)^{th}-level driving circuit of the driving module is electrically coupled to a fourth clock signal line, and configured to generate an (8n−5)^{th} scanning signal according to a fourth clock signal provided by the fourth clock signal line;
an (8n−3)^{th}-level driving circuit of the driving module is electrically coupled to a fifth clock signal line, and configured to generate an (8n−5)^{th} scanning signal according to a fifth clock signal provided by the fifth clock signal line;
an (8n−2)^{th}-level driving circuit of the driving module is electrically coupled to a sixth clock signal line, and configured to generate an (8n) scanning signal according to a sixth clock signal provided by the sixth clock signal line;
an (8n−1)^{th}-level driving circuit of the driving module is electrically coupled to a seventh clock signal line, and configured to generate an (8n−2)^{th} scanning signal according to a seventh clock signal provided by the seventh clock signal line; and
an (8n)^{th}-level driving circuit of the driving module is electrically coupled to an eighth clock signal line, and configured to generate an (8n−1)^{th} scanning signal according to an eighth clock signal provided by the eighth clock signal line, where n is a positive integer.

18. The display device according to claim 16, wherein an (8n−7)^{th}-level driving circuit of the driving module is electrically coupled to a first clock signal line, and configured to generate an (8n−7)^{th} scanning signal according to a first clock signal provided by the first clock signal line;
an (8n−6)^{th}-level driving circuit of the driving module is electrically coupled to a third clock signal line, and configured to generate an (8n−6)^{th} scanning signal according to a third clock signal provided by the third clock signal line:
an (8n−5)^{th}-level driving circuit of the driving module is electrically coupled to a fourth clock signal line, and configured to generate an (8n−5)^{th} scanning signal according to a fourth clock signal provided by the fourth clock signal line;
an (8n−4)^{th}-level driving circuit of the driving module is electrically coupled to a second clock signal line, and configured to generate an (8n−4)^{th} scanning signal according to a second clock signal provided by the second clock signal line;
an (8n−3)^{th}-level driving circuit of the driving module is electrically coupled to a fifth clock signal line, and configured to generate an (8n−3)^{th} scanning signal according to a fifth clock signal provided by the fifth clock signal line;
an (8n−2)^{th}-level driving circuit of the driving module is electrically coupled to a seventh clock signal line, and configured to generate an (8n−2)^{th} scanning signal according to a seventh clock signal provided by the seventh clock signal line;
an (8n−1)^{th}-level driving circuit of the driving module is electrically coupled to an eighth clock signal line, and configured to generate an (8n−1)^{th} scanning signal according to an eighth clock signal provided by the eighth clock signal line; and
an (8n)^{th}-level driving circuit of the driving module is electrically coupled to a sixth clock signal line, and configured to generate an (8n)^{th} scanning signal according to a sixth clock signal provided by the sixth clock signal line, where n is a positive integer.

19. The display device according to claim 14, wherein subpixels in a (3a−2)^{th} column have a first color, subpixels in a (3a−1)^{th} column have a second color, and subpixels in a (3a)^{th} column have a third color;
subpixels in a (4m−2)^{th} row and odd-numbered columns are electrically coupled to an (8m−4)^{th} scanning line, and subpixels in the (4m−2)^{th} row and even-numbered columns are electrically coupled to an (8m−3)^{th} scanning line;
subpixels in a (4m−1)^{th} row and the odd-numbered columns are electrically coupled to an (8m−3)^{th} scanning line, and subpixels in the (4m−1)^{th} row and the even-numbered columns are electrically coupled to an (8m−2)^{th} scanning line;
subpixels in a (4m)^{th} row and the odd-numbered columns are electrically coupled to an (8m−1)^{th} scanning line, and subpixels in the (4m)^{th} row and the even-numbered columns are electrically coupled to an (8m)^{th} scanning line; and
subpixels in a (4m+1)^{th} row and the odd-numbered columns are electrically coupled to an (8m+2)^{th} scanning line, and subpixels in the (4m+1)^{th} row and the even-numbered columns are electrically coupled to an (8m+1)^{th} scanning line, where a and m are both positive integers.

20. The display device according to claim 19, wherein a subpixel in the (4m−2)^{th} row and a (2b−1)^{th} column, a subpixel in the (4m−2)^{th} row and a (2b)^{th} column, a subpixel in the (4m−1)^{th} row and the (2b−1)^{th} column and a subpixel in the (4m−1)^{th} row and the (2b)^{th} column are electrically coupled to a bah data line; and
a subpixel in the (4m)^{th} row and the (2b−1)^{th} column, a subpixel in the (4m)^{th} row and the (2b)^{th} column, a subpixel in the (4m+1)^{th} row and the (2b−1)^{th} column and a subpixel in the (4m+1)^{th} row and the (2b)^{th} column are electrically coupled to a (b+1)^{th} data line, where b is a positive integer.
